(19) United States
(12) Patent Application Publication
(10) Pub. No.: US 2026/0351734 A1
(43) Pub. Date: Nov. 5, 2026

(54) SYSTEMS AND METHODS FOR PHASE CHANGE MATERIAL HEAT EXCHANGER FOR BATTERY ENERGY STORAGE SYSTEM

(71) Applicant: LG Energy Solution, Ltd., Seoul (KR)

(72) Inventor: Andrew PITTS, Westborough, MA (US)

(73) Assignee: LG Energy Solution, Ltd., Seoul (KR)

(21) Appl. No.: 19/557,562

(22) Filed: Mar. 5, 2026

Related U.S. Application Data
(60) Provisional application No. 63/768,606, filed on Mar. 7, 2025.

(51) Int. Cl. H01M 10/659; H01M 10/42; H01M 10/613; H01M 10/627; H01M 10/63; H01M 10/6561; H01M 10/6567; H01M 10/6569

(52) U.S. Cl. CPC H01M 10/659; H01M 10/425; H01M 10/613; H01M 10/627; H01M 10/63; H01M 10/6561; H01M 10/6567; H01M 10/6569; H01M 2010/4271; H01M 2220/10

(57) ABSTRACT

A battery electronic storage system includes: a battery assembly; a battery assembly cooling system including: a PCM, and a battery heat exchanger to transfer heat from the battery assembly to a first liquid coolant, and to transfer heat from the first liquid coolant in a first mode and a second mode; a PCM cooling system including a PCM heat exchanger to transfer heat from the PCM to one or more of a second liquid coolant or air; and one or more controllers configured to: control the battery assembly cooling system to operate the battery heat exchanger in each of the first mode or the second mode, based on a temperature of the air and a temperature of the PCM, and control the PCM cooling system to transfer heat from the PCM to the one or more of the second liquid coolant or the air.

### CROSS-REFERENCE TO RELATED APPLICATIONS

This application claims priority to U.S. Provisional Application No. 63/768,606, filed Mar. 7, 2025, which is hereby incorporated by reference in its entirety.

### TECHNICAL FIELD

Various embodiments of the present disclosure relate generally to systems and methods for thermal management of battery energy storage systems, and more particularly to a phase change material heat exchanger system for cooling battery assemblies through thermal peak shaving and energy storage applications.

### BACKGROUND

Battery Energy Storage Systems (BESS) have emerged as critical components in modern energy infrastructure. As renewable energy sources such as wind and solar power become increasingly integrated into electrical grids, their inherent intermittency creates challenges for grid stability and efficient power distribution. Beyond renewable energy applications, BESS also provides significant benefits for conventional energy generation systems by enabling load leveling, frequency regulation, and peak shaving for traditional power plants including coal, natural gas, and nuclear facilities. These systems help conventional generators operate more efficiently by reducing the need for rapid ramping, and by providing grid services that improve overall system reliability. BESS technology addresses these challenges by storing excess electricity generated during periods of low demand and releasing it during peak demand periods. This capability optimizes energy usage by reducing curtailment of renewable electricity, improving efficiency of (and reducing reliance on) fossil fuel-based power generation such as gas turbines, and supports climate change mitigation efforts by reducing greenhouse gas emissions. The importance of BESS technology continues to grow as the global energy transition accelerates and intermittent renewable sources capture larger shares of the electricity supply mix.

Commercially available batteries may include nickel-cadmium batteries, nickel-hydrogen batteries, nickel-zinc batteries, lithium, sodium-ion, lithium iron phosphate, lithium-sulfur, solid-state batteries, and the like. Among these, lithium batteries may be gaining attention due to their advantageous characteristics: they can be charged and discharged freely without memory effects, they exhibit very low self-discharge rates, and they provide high energy density compared to nickel-based alternatives. Similarly, sodium-ion batteries are emerging as promising alternatives to lithium batteries, driven by the abundance of sodium resources and their potential cost advantages.

In general, battery packs or racks typically comprise multiple cells or cell stacks arranged in series or parallel configurations. Each cell or cell stacks contains either a single battery cell or multiple battery cells connected in series. The operational state of each cell stack within the battery pack is continuously monitored by a controller equipped with a battery management system. Battery cells may be integrated directly into packs or racks, or alternatively organized into modules, with these modules then connected in series or parallel arrangements to form complete battery packs or racks. The state of each cell stack included in the battery pack may be monitored by a controller having a battery management system mounted thereon. The controller may output signals for controlling the balancing operation, cooling operation, and discharging operation based on the monitored state from each cell stack.

Conventional energy storage systems are typically configured in containerized units, where each container housing may include multiple battery racks, switchboards, HVAC systems, thermal runaway detection systems, fire suppression systems, ventilation equipment, power distribution units, monitoring sensors, safety interlocks, and other components. These containers are designed with sufficient capacity to accommodate all necessary energy storage system components within their structure. At grid scale, BESS units may be used to store reserve power to even power entire cities in the event of blackouts or other interruptions in electrical service.

During operation, battery energy storage systems generate substantial amounts of heat due to internal resistance and electrochemical processes occurring within the battery cells. This heat generation becomes particularly pronounced during high-rate charging and discharging cycles, which are common in grid-scale applications where rapid response to demand fluctuations is required. The thermal behavior of battery systems directly impacts their performance, efficiency, safety, and operational lifespan. Elevated temperatures can accelerate chemical degradation processes within battery cells, leading to capacity fade and reduced cycle life. Conversely, operation at excessively low temperatures can result in decreased power output and charging efficiency.

Thermal management systems for battery energy storage applications face several challenges related to the variable and unpredictable nature of thermal loads. Battery systems experience significant variations in heat generation depending on operational conditions, ambient temperature, and duty cycles. During peak demand periods, multiple battery modules may operate simultaneously at high power levels, creating concentrated thermal loads that can overwhelm conventional cooling systems. Additionally, the thermal characteristics of large-scale battery installations can vary significantly across different sections of the system due to factors such as airflow patterns, proximity to heat sources, and variations in battery cell performance.

Traditional cooling approaches for battery energy storage systems typically rely on air conditioning systems or liquid cooling circuits that operate continuously or are activated based on temperature thresholds. These conventional thermal management systems often consume substantial amounts of energy, particularly during periods of high ambient temperature when cooling demands are greatest. The energy consumption of thermal management systems can represent a significant portion of the overall system losses, thereby reducing the round-trip efficiency of the energy storage system. Furthermore, conventional cooling systems may struggle to maintain uniform temperature distribution across large battery arrays, potentially leading to thermal gradients that can affect system performance and longevity.

The sizing and capacity requirements for conventional thermal management systems are typically determined by peak thermal loads, which may occur infrequently but require substantial cooling capacity when they do occur. This approach can result in oversized cooling equipment that operates inefficiently during normal operating conditions. Additionally, the electrical power required to operate cooling systems during peak demand periods can conflict with the primary function of the battery energy storage system, which is to provide power to the grid during these same high-demand periods.

The present disclosure is directed to overcoming one or more of these above-referenced challenges.

### SUMMARY OF THE DISCLOSURE

In some aspects, the techniques described herein relate to a battery electronic storage system including: a battery assembly; a battery assembly cooling system, the battery assembly cooling system including: a phase change material (PCM), and a battery heat exchanger to transfer heat from the battery assembly to a first liquid coolant, and to transfer heat from the first liquid coolant in a first mode and a second mode, wherein the battery heat exchanger operates in the first mode to transfer heat from the first liquid coolant to air and operates in the second mode to transfer heat from the first liquid coolant to the PCM; a PCM cooling system, the PCM cooling system including a PCM heat exchanger to transfer heat from the PCM to one or more of a second liquid coolant or air; and one or more controllers configured to: control the battery assembly cooling system to operate the battery heat exchanger in each of the first mode or the second mode, based on a temperature of the air and a temperature of the PCM, and control the PCM cooling system to transfer heat from the PCM to the one or more of the second liquid coolant or the air, based on the temperature of the air and the temperature of the PCM.

In some aspects, the techniques described herein relate to a battery electronic storage system, wherein the one or more controllers are further configured to: control the battery assembly cooling system to operate the battery heat exchanger in the first mode to transfer heat from the first liquid coolant to air when the temperature of the PCM is greater than the temperature of the air, control the battery assembly cooling system to operate the battery heat exchanger in the second mode to transfer heat from the first liquid coolant to the PCM when the temperature of the PCM is less than the temperature of the air, and control the PCM cooling system to transfer heat from the PCM to the one or more of the second liquid coolant or the air when the temperature of the PCM is greater than the temperature of the air.

In some aspects, the techniques described herein relate to a battery electronic storage system, wherein the one or more controllers are further configured to: control the battery assembly cooling system to operate the battery heat exchanger in a third mode to transfer heat from the first liquid coolant to both the air and the PCM when a temperature of the battery assembly is greater than the temperature of the PCM.

In some aspects, the techniques described herein relate to a battery electronic storage system, wherein the one or more controllers are further configured to: control the PCM cooling system to transfer heat from the PCM to the second liquid coolant and from the second liquid coolant to the air when the temperature of the PCM is greater than a freezing temperature of the PCM and less than the temperature of the air, and control the PCM cooling system to transfer heat from the PCM to the air when the temperature of the PCM is greater than the freezing temperature of the PCM and greater than the temperature of the air.

In some aspects, the techniques described herein relate to a battery electronic storage system, wherein: the battery assembly includes one or more battery modules, and the battery heat exchanger includes one or more cooling plates with one or more cooling channels for the first liquid coolant to transfer heat from the one or more battery modules to the first liquid coolant.

In some aspects, the techniques described herein relate to a battery electronic storage system, wherein the battery heat exchanger includes a battery system air condenser to transfer heat from the first liquid coolant to air.

In some aspects, the techniques described herein relate to a battery electronic storage system, wherein the battery heat exchanger includes a battery system PCM condenser to transfer heat from the first liquid coolant to the PCM.

In some aspects, the techniques described herein relate to a battery electronic storage system, wherein the PCM heat exchanger includes one or more fans to move air across the PCM to transfer heat from the PCM to the air.

In some aspects, the techniques described herein relate to a battery electronic storage system, wherein the PCM heat exchanger includes one or more PCM system coils for the second liquid coolant to transfer heat from the PCM to the second liquid coolant.

In some aspects, the techniques described herein relate to a battery electronic storage system, wherein the PCM heat exchanger includes a PCM system condenser to transfer heat from the second liquid coolant to air.

In some aspects, the techniques described herein relate to a battery electronic storage system, wherein: the battery heat exchanger includes a battery system PCM condenser at the PCM to transfer heat from the first liquid coolant to the PCM, and the PCM heat exchanger includes a PCM evaporator at the PCM to transfer heat from the PCM to the second liquid coolant.

In some aspects, the techniques described herein relate to a battery electronic storage system including: a battery assembly; a battery assembly cooling system, the battery assembly cooling system including: a liquid coolant, a phase change material (PCM), and a heat exchanger system to transfer heat from the battery assembly to the liquid coolant, to transfer heat from the liquid coolant to air, to transfer heat from the liquid coolant to the PCM, to transfer heat from the PCM to the liquid coolant, and to transfer heat from the PCM to air, and one or more controllers configured to control the heat exchanger system based on a temperature of the battery assembly, a temperature of the liquid coolant, a temperature of the air, and a temperature of the PCM.

In some aspects, the techniques described herein relate to a battery electronic storage system, wherein the one or more controllers are configured to control the heat exchanger system: to transfer heat from the battery assembly to the liquid coolant when a temperature of the battery assembly is greater than a temperature of the liquid coolant, to transfer heat from the liquid coolant to air when the temperature of the liquid coolant is greater than a temperature of the air, to transfer heat from the liquid coolant to the PCM when the temperature of the liquid coolant is greater than a temperature of the PCM, to transfer heat from the PCM to the liquid coolant when the temperature of the PCM is greater than the temperature of the liquid coolant, and to transfer heat from the PCM to air when the temperature of the PCM is greater than the temperature of the air.

In some aspects, the techniques described herein relate to a battery electronic storage system, wherein a melting point of the PCM is from approximately 0 degrees F to approximately 100 degrees F.

In some aspects, the techniques described herein relate to a battery electronic storage system, wherein the PCM is configured to transition from a solid to a liquid at the melting point.

In some aspects, the techniques described herein relate to a battery electronic storage system, further including: a first enclosure for the battery assembly; and a second enclosure for the PCM.

In some aspects, the techniques described herein relate to a battery management system including: one or more controllers configured to control a battery electronic storage system including a battery assembly, wherein the one or more controllers are configured to control a heat exchanger system of the battery electronic storage system to control a temperature of the battery assembly, and to transfer heat from the battery assembly to a first liquid coolant, to transfer heat from the first liquid coolant to air, to transfer heat from the first liquid coolant to a phase change material (PCM), to transfer heat from the PCM to one or more of the first liquid coolant or a second liquid coolant, and to transfer heat from the PCM to air.

In some aspects, the techniques described herein relate to a battery management system, wherein the one or more controllers are further configured to control the heat exchanger system to: transfer heat from the PCM to air when a temperature of the PCM is greater than a temperature of the air, and transfer heat from the PCM to the one or more of the first liquid coolant or the second liquid coolant when the temperature of the PCM is less than the temperature of the air.

In some aspects, the techniques described herein relate to a battery management system, wherein the one or more controllers are further configured to control the heat exchanger system to transfer heat from the PCM to the first liquid coolant when the heat exchanger system is configured to cool both the battery assembly and the PCM using the first liquid coolant.

In some aspects, the techniques described herein relate to a battery management system, wherein the one or more controllers are further configured to control the heat exchanger system to transfer heat from the PCM to the second liquid coolant when the heat exchanger system is configured to cool both the battery assembly using the first liquid coolant and the PCM using the second liquid coolant.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure for a battery, according to one or more embodiments.

FIG. 2 depicts a battery, according to one or more embodiments.

FIG. 3 depicts a controller, according to one or more embodiments.

FIG. 4 depicts a thermal management system for battery energy storage applications, according to one or more embodiments.

FIG. 5 depicts a detailed thermal management system for battery energy storage applications, according to one or more embodiments.

FIG. 6 depicts a power consumption graph showing power consumption at different operating conditions, according to one or more embodiments.

FIG. 7 depicts a phase change material properties table, according to one or more embodiments.

FIG. 8 depicts an energy graph illustrating thermal management benefits, according to one or more embodiments.

FIG. 9 depicts a phase change material phase graph, according to one or more embodiments.

FIG. 10 depicts a phase change graph illustrating temperature and stored heat relationships, according to one or more embodiments.

### DETAILED DESCRIPTION OF EMBODIMENTS

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Various embodiments of the present disclosure relate generally to systems and methods for thermal management of battery energy storage systems, and more particularly to a phase change material heat exchanger system for cooling battery assemblies through thermal peak shaving and energy storage applications.

Batteries may have a variety of shapes, also known as form factors. Common battery form factors include pouch-type, prismatic-type, and cylindrical-type.

Pouch-type battery cells can be produced in various lengths and widths, which may enhance the battery capacity and allow optimization of battery cells. The flexible pouch-type battery can provide significant advantages over rigid battery formats, including improved mechanical flexibility that allows the battery to conform to curved or irregular surfaces in electronic devices. This flexibility enables manufacturers to integrate pouch-type batteries into compact spaces and unconventional form factors, such as wearable devices, smartphones with curved displays, and automotive applications where space constraints require batteries to fit around other components. The lightweight and thin profile of pouch-type batteries also facilitates easier incorporation into products where weight and thickness are critical design considerations, such as tablets, laptops, and electric vehicle applications. Additionally, the pouch format allows for more efficient use of available space within a device enclosure, as the flexible packaging can be shaped to increase energy density while reducing wasted volume compared to cylindrical or prismatic battery formats.

Prismatic battery cells offer may offer advantages in applications requiring efficient space utilization and thermal management. Their rectangular form factor allows for optimal packing density within battery modules and packs, reducing wasted space and enabling higher energy density per unit volume. The flat surfaces of prismatic cells may facilitate improved heat dissipation and thermal contact with cooling systems, which can enhance overall battery performance and safety. The outer shell of prismatic cells are typically made of aluminum alloy or steel, and are typically heavier than pouch-type battery cells, making them ideal for situations where weight is a less important design consideration.

Cylindrical battery cells may provide robust mechanical strength and proven manufacturing scalability that may benefit high-volume production applications. The cylindrical geometry distributes internal pressure more evenly during charging and discharging cycles, potentially contributing to enhanced structural integrity and longer cycle life. These cells may also offer advantages in automated manufacturing processes due to their uniform shape and established production techniques, which can result in consistent quality and cost-effective mass production. Cylindrical cells are typically heavier than prismatic cells, and further have reduced energy density, as packing the batteries together typically results in gaps or spaces between the cells that are not present in pouch and prismatic form factor designs.

Modules and packs can be produced in various designs to accommodate various products. Batteries may include one or more of a tab structure, a tab-less structure, or a jelly roll design. A tab-less jelly roll design may reduce resistance while increasing power output. A zig-zag stacking design may include cross-stacking technology that alternates cathode and anode sheets with separators, enhancing both precision and safety. A Cell Array Structure (CAS) structure for batteries may increase structural rigidity, enhance cooling efficiency, and ensure superior safety.

The assembly of the “cylindrical battery”, the most commonly encountered battery form in our daily life, starts with “winding”. Winding is a process where a machine called a winder rolls up the cathode and anode electrodes. This process has the advantage of being very fast, similar to how a “tissue roll” can quickly wrap the paper around the tissue core. During winding, cathode, anode, and separator rolls are unwound, and an aluminum tab is attached to the cathode's blank part while a copper tab is attached to the anode's blank part. Then they are attached to the winder in the order of cathode-separator-anode-separator, wound around a mandrel, like rolling toilet paper around its core, and then cut into an appropriate size to form a jelly roll.

Once the jelly roll is formed, it goes through various assembly processes to take the form of the familiar cylindrical battery. At first, the jelly roll produced by the winding method is inserted into a can so that the anode touches its bottom and the anode tab is bent at a 90-degree angle to make contact with the anode. After inserting the jelly roll into the can, it is attached using a resistance welding method. Resistance welding is also known as “spot welding” because bead-like spots are created when the metal melts and solidifies. After welding, a process called “beading” is used to create the neck of the cell, allowing the top cap to be fitted later.

Once the cylindrical shape of the battery is completed through beading, electrolyte is injected. To do this, a vacuum is created inside of the can and the electrolyte is injected into it through a nozzle. Then, the can is pressed to let the electrolyte fill the pores of the electrode. Once the electrolyte injection is complete, the cathode tab and the top cap are attached to the cell using laser welding. Finally, the cylindrical battery is completed by mechanically sealing it through the crimping and sizing processes, producing it to standardized dimensions. After the assembly process is completed, the battery undergoes cleaning, quality verification, and formation processes before being delivered to the customers.

Pouch-type batteries may be manufactured differently from cylindrical batteries. To place battery materials into the electrode pocket of a pouch case, a mono-cell is required. A mono-cell is the basic unit of a battery, consisting of a cathode, an anode, and two separators arranged in a layered structure, such as “separator-central electrode-separator-external electrode.” The lamination and stacking processes are applied to this mono-cell. To be more specific, the process begins with lamination, a method for aligning and bonding the cathode, anode, and separator. This is followed by stacking, during which monocells are repeatedly layered. Finally, stacking half-cells each made up of two separators and an anode-forms a cell stack, where the cathode and anode are alternately layered with separators in between. Lamination & stacking technology increases space efficiency within the pouch case, further enhancing energy density. Stacking, which involves individually layering battery cells, requires advanced technical expertise. By applying lamination & stacking, misalignment between cells is reduced, and empty spaces within the battery cell are eliminated, resulting in higher energy density. Lamination & stacking technology with mono-cells may be used to produce a range of pouch-type batteries, from ultra-thin batteries under 2 mm to long cells.

The cell stack, produced through lamination and stacking, then moves to the packaging stage. First, leads are welded onto the cell stack, which comprises multiple layers of mono-cells. Next, a pouch film is compressed to form a pocket, and the lead-welded cell stack is inserted into this pouch pocket for assembly. To seal the pocket, heat and pressure are applied using a sealing tool.

During this process, two pockets are formed: the electrode pocket and the gas pocket. The electrode pocket houses the cell stack, including the cathode, anode, separator, and electrolyte. The gas pocket, meanwhile, serves as an entry for electrolyte injection and as a space to store gases generated during the injection process. After injecting the electrolyte into the gas pocket, the injection port is sealed with the sealing tool, completing the assembly of the pouch-type battery. In the following formation process, any unwanted gases that are generated and accumulated in the gas pocket are removed during the degassing stage by trimming the gas pocket.

Prismatic battery cell manufacturing may share some similarities with cylindrical cell production, while incorporating unique processes tailored to the rectangular form factor. The manufacturing process typically begins with electrode preparation, where cathode and anode materials are coated onto current collectors, similar to other battery types. However, prismatic cells may utilize either a winding process similar to cylindrical cells or a stacking process similar to pouch cells, depending on the specific design requirements and manufacturer preferences. The electrode assembly is then inserted into a rigid metal casing, which may be made of aluminum alloy or steel, providing structural integrity that differs from the flexible pouch format.

The assembly and sealing processes for prismatic cells may involve specialized techniques that accommodate the rectangular geometry and rigid housing. Electrolyte injection in prismatic cells may require precise control to ensure uniform distribution throughout the rectangular cell structure, which can be more challenging than the cylindrical geometry due to potential dead zones in corners. The sealing process typically involves laser welding or mechanical crimping of the metal casing, providing a hermetic seal that may offer enhanced safety compared to pouch cells but requires more complex manufacturing equipment than cylindrical cells. Quality control and formation processes for prismatic cells may need to account for the unique thermal and electrical characteristics of the rectangular form factor, potentially requiring different testing protocols compared to cylindrical or pouch cell manufacturing.

After completion of the formation and acquiring electrical characteristics, batteries are either delivered as individual cells or modularized to suit (or fit) electric vehicle models. The pack process involves modularizing the battery cells and placing them into packs before final delivery.

The first step in the pack process is to bundle battery cells to build a module. First, several surface-cleaned battery cells are arranged in a “cell to cell” configuration, which are retained into a module case with adhesives. Then bus bars and leads are welded to connect to the cells with a laser welder, and the module build is completed with installing module top cover. Finally, a pack build is completed when these modules are placed into the battery pack enclosures and connected to each other. These complete battery packs are then installed in many applications such as electric vehicles and various IT devices. The number of cells and modules in a battery pack may vary, depending on the battery cells and application models.

Because a battery pack contains multiple cells or modules, balancing and managing these cells is critical, especially to accurately measure state of charge and optimize battery life. Therefore, once a pack is assembled, the battery is monitored, and its performance maintained in optimal conditions using a control system called BMS (Battery Management System), which estimates the battery's charging state and life. The CMS (Cell Monitoring System) inside the BMS measures the cells' condition and performs balancing to ensure optimal battery performance, safety, and life.

“Cell balancing” refers to adjusting the voltage differences between two or more serially connected cells. For instance, if two cells connected in series reach voltages of 4.2V and 4.0V, respectively, during charging, cell balancing adjusts this 0.2v difference to equalize the voltage. Voltage imbalance can occur due to manufacturing or external factors, and it can affect battery capacity and life, posing risks of overcharging, over-discharging, and fire hazards. Hence, cell balancing is essential.

Mobility and IT battery products have a wide variety of applications in IT devices such as smartphones and laptops, as well as LEVs (Light Electric Vehicles), electric bicycles, power tools, and wireless earphones. In general, energy is difficult to store and is lost after being used. Energy Storage Systems (ESS) are systems that store and manage energy so the energy can be used more efficiently. ESS has applications in power plants, power transmission and distribution facilities, homes, factories, and businesses. Through a system that is coupled with renewable energy, ESS can increase the efficiency of renewable energy and reduce electricity costs. ESS can also be used as backup power to reduce damages from power outages.

For example, solar modules installed on the roof of homes and ESS for uninterruptible power supply (UPS) in data centers store power and use the stored power during times of high demand or when electricity prices are high. In turn, ESS reduces damages from blackouts and saves electricity bills. Also, power plants can store and manage irregularly produced renewable energy, such as solar, wind, and hydroelectric power, which increases the efficiency of their use.

When used in conjunction with solar panel installations at home, ESS stores electricity produced by solar panels during daytime to be used at nighttime. A home battery may be a solution that can serve as an alternative energy source to reduce electricity costs and prepare for power outages. Installing ESS and solar power systems together generates power independently, increasing the self-consumption of power at home and reducing the overall electricity cost.

ESS for power grids, also commonly referred to as BESS, may be installed proximate to thermal power plants, solar and wind power plants, and substations. ESS for power grids has various applications in reducing power load, coupling with renewable power generation, and adjusting power frequency. Commercial ESS installed in commercial buildings such as offices, schools, factories, data centers, and the like may be used to reduce power load, or may be coupled with renewable power generation. ESS may include backup power solutions that protect facilities that require the constant supply of power, such as data centers and IT/telecommunications facilities. ESS may also be used to enable participation in an optimized energy marketplace, where excess power is sold back to the grid during peak hours and charged during off-peak hours. While BESS is ideal for use with renewable energy systems, BESS can store energy from many different sources, including energy generated by fossil fuels, hydropower, or any other power source that generates usable electricity.

An ESS is a system that stores electricity produced and supplies it when needed, thereby enhancing energy efficiency. It mainly includes four components: a battery, a power conversion system (PCS), a battery management system (BMS), and an energy management system (EMS). The PCS is a power conversion device that converts alternating current to direct current and vice versa. The BMS is a battery management system that typically monitors and/or controls one or more battery cells, packs, racks, and/or modules in the ESS, and includes safety features that stop charging and discharging if abnormalities in voltage, current, or temperature are detected. The EMS is a system that monitors the amount of electricity stored in the ESS and serves as a software responsible for the overall operation of the ESS.

There are three primary roles of ESS. First, it acts as an uninterrupted power supply in places where power outages must be avoided at all costs, such as hospitals and banks. In cases of power outages caused by typhoons or fires, it assists in power supply to prepare for large-scale blackout situations. Second, it stores generated energy and supplies it during peak power demand times. It helps to stabilize energy output by compensating for the inconsistent generation levels of new renewable energies such as solar and wind power. In homes, it can save on electricity bills by storing electricity during cheaper hours and using it during more expensive daytime hours. Third, it maintains the standard power frequency at 60 Hz in the power supply system, countering frequency fluctuations due to mismatches in supply and demand, thereby enhancing power quality.

A battery system may include controlling power to and from batteries and providing control signals. A battery energy storage system (BESS) may include a battery management system (BMS), a local energy management system (EMS), external data reporting, a power plant controller, a utility EMS, and fleet-level controls. The BMS may collect inputs from battery cells and modules, and may operate individual cells or groups of cells. The BMS may include a controller. The BMS may balance voltages in the battery cells, for example. The local EMS may collect information from the BMS, and may control the operations of the BMS at a system level. The EMS may determine available power and capacity of the BESS, for example. External data reporting may include components such as transformers, switchgear, or meters. The power plant controller may coordinate the local EMS with a supervisory system. The utility EMS may control an electrical grid connected to the BESS. The fleet-level controls may coordinate to operate multiple BESS's at different locations. Communications between these components may be established wirelessly or through connected wires, depending on the system configuration and operational requirements.

BMS is a management system to monitor and control the status of batteries to operate them under optimal conditions. It measures the current, voltage, and temperature of batteries in Battery Electric Vehicles (BEVs) or Energy Storage Systems (ESS) with sensors, and identifies and controls potential concerns so that the batteries can maintain the highest performance possible. The location of the BMS can vary depending on the battery type or product.

The battery system includes the cell as the smallest unit, the module of a group of cells, and the pack of the final form of the battery. The role of BMS in a battery can be compared to that of a choir conductor. As a conductor sets the tone and tempo to combine different voices of the choir into a harmonious song, BMS tunes the current and voltage of each cell like a conductor.

BMS performs three main functions: monitoring, cell management, and control. Monitoring involves observing voltage, current, temperature, etc., through sensors in the battery system, and predicting state of charge (SoC) and the state of health (SoH) of the battery based on the data. Cell management refers to cell balancing, which reduces the voltage differences between battery cells to enhance energy efficiency and charging rate. Control is the process of regulating to prevent overcharging, over-discharging, and overcurrent in the battery. Ultimately, BMS plays a role in managing the life, performance, and safety of the battery, and as batteries continue to develop, BMS is also becoming more sophisticated and continues to evolve.

“C-rate” is a term one needs to know when dealing with fast charging speeds to the extent of acquiring special chargers and cables capable of rapid charging. Abbreviated from “current rate”, the C-rate is a measure of the rate at which a battery is charged or discharged. It is also called “charge and discharge rates” and uses “C” as the unit, which is the abbreviation of “capacity”. C-rate can be calculated by dividing the charging or discharging current (A) by the rated battery capacity (Ah). The standard C-rate is generally 1 C.

Understanding the C-rate is very helpful when using batteries. First, the charge C-rates help users estimate how long it will take to fully charge their batteries. For example, when one sees a battery label that states, “Chargeable at 10 C,” it means the battery can be charged at a current of 10 times the battery capacity, and it takes at least 6 minutes to be completely charged.

On the other hand, the discharge C-rates help users predict the limits of product performance. For instance, a drone battery with a high discharge C-rate indicates a faster discharge rate, meaning it can perform complex maneuvers that require sudden high currents. Conversely, a low discharge C-rate could mean difficulty in performing high-performance actions that require high currents. Let us suppose that there is a drone battery with a discharge C-rate of 100 C. The battery can supply a current of up to 100 times its capacity, but if the drone continues the move that requires that much power, it is discharged 100 times faster than the standard of an hour (3,600 seconds). Accordingly, it is discharged in just 36 seconds. As the use of batteries in our daily lives increases, and more products require fast charging or a sudden rush of high current, understanding the concept of C-rate will help us choose the right battery for each electronic device.

When we use portable electronic devices, we always check the battery's charge status. For instance, the battery icon on a phone shows percentages like 100%, 50%, 20%, etc. This indicator, showing how much percentage of the battery is left, is known as “SoC”. Soc stands for “State of Charge”. It represents the remaining battery capacity in percentage (%) which is the current usable battery capacity divided by the total capacity.

Accurate SoC measurement is a core competitive aspect for battery manufacturers. As such, there are various methods to measure SoC, including chemical, voltage, current integration, and pressure measurement methods. SoC is an element to provide convenience to users. Through SoC measurements, it is possible to determine how much longer the battery can be used more and users can determine when to charge and end the battery themselves, allowing them to use the device more efficiently. From the manufacturer's perspective, SoC is considered very important as it can enhance the stability of the battery. By setting the maximum charge of the battery lower than the highest point of the SoC and the minimum charge of the battery higher than the lowest point of the SoC, various problems such as safety issues due to overcharging and over-discharging of the battery can be prevented in advance. As a result, a more stable battery usage environment can be provided to users.

Batteries, like all other products, have a lifespan. The SoH (State of Health) is a useful indicator for the remaining life and the current state of batteries. It shows the battery's condition compared to its initial conditions at a glance. One can easily check the SoH on some smartphones, tablets, or laptops. Devices that do not provide SoH information, such as “maximum battery performance”, can be assessed through specialized testing equipment. However, SoHs can vary even among batteries that have been used for the same period because battery life is affected by many factors, including user habits and the environment. In particular, if the electric vehicle battery is well managed, it is possible to drive the vehicle for 2 to 3 times longer than the manufacturer's warranty period with little decrease in SoH. SoH is referred to as “Maximum capacity” on some devices.

Recently, with many second-hand transactions taking place in real life, transactions of IT devices with batteries, such as smartphones and tablet PCs, are also increasing. At this time, SoH is a factor that must be checked to trade better products. Not only a second-hand transaction, but also an IT device with a built-in battery can be used more efficiently if the health status of the battery is checked with the SoH.

A cell is the basic unit of a battery. In devices requiring a lot of power, like electric vehicles, a battery pack contains numerous cells. However, even identical cells may develop voltage differences due to manufacturing processes or external factors. For example, when two cells connected in series are charged, the first cell could reach 4.2 V while the second cell stops at 4.0 V. Such imbalances between cells can affect battery capacity and life, and significantly increase the risk of safety issues due to overcharging and over-discharging. To prevent this, “cell balancing” is necessary.

Cell balancing adjusts and aligns the voltage differences between serially connected battery cells. It can be of two types: passive and active. Passive cell balancing dissipates the charging energy of a cell through a resistance to lower the cell voltage. In other words, it removes the charge from cells with more capacity by dissipating heat, making the charge of all cells uniform. While this method is simple and cost-effective, it is less energy-efficient as it wastes excess voltage and can only be applied during charging.

Active cell balancing transfers the charging energy from cells with higher voltage to those with lower voltage. It redistributes the charge to equalize the voltage between cells by providing more capacity to cells with less capacity. Unlike passive cell balancing, which dissipates heat, active balancing redistributes energy, making it more energy-efficient and faster in charging. While active cell balancing can be applied during both charging and discharging, it involves more complex additional circuitry and is thus more costly. Cell balancing happens in the BMS (Battery Management System), where the CMU (Cell Monitoring Unit) in the BMS measures the state of the cells and starts balancing, enabling safer use of the battery.

One or more embodiments may relate to a system level cooling design based on phase change material integrated heat exchanger for thermal peak shaving application in BESS applications. One or more embodiments may provide integration into unit container/building/enclosure or outside unit. The system may sink to air or ground temperature. One or more embodiments may provide reduced power consumption required for cooling system by storage of cooling capacity at melting temperature. The system may sink to air/ground using a fan or HVAC/chiller unit at cooler nighttime temperatures.

One or more embodiments may include operational design modes that may reduce the number of HVAC/chiller units required. Cooling may be dependent on ambient temperatures reaching the chosen PCM freezing temperature. PCM may be charged at freezing temperature the night before when the cooling system can operate at a more efficient outdoor temperature and aux power may be cheaper. A hypothetical nighttime temperature operating point may be 4500 W. A hypothetical daytime temperature operating point may be 5500 W.

One or more embodiments may include operational design modes where the cooling loop can operate in an economizer mode rejecting heat straight to the outdoor ambient using fans if there may be a favorable temperature delta. PCM may be charged without a vapor compression cycle (chiller/HVAC) utilizing fans if the outdoor temperature may be lower than the melting temperature. PCM may be charged with a small chiller/HVAC unit that operates over a longer period of time reducing the number of cooling units and maintenance required.

For an exemplary first battery 0.5 CP at approximately 35 kW peak cooling may be required for 1,200 kW BES 4 hour system. An average of approximately 15 kW may be required during a charge/discharge cycle. Load may be 15 kW×4 hr=60 kWh. For S27 PCM, tank capacity may be 56 kWh/m\hat{ }3. Tank Volume may be approximately 1 m\hat{ }3. For an exemplary second battery, assuming the same heat generation, approximately 75 kW average may be required. Therefore, 1 m\hat{ }3 of PCM may reduce the cooling load by approximately 20%.

One or more embodiments may utilize various PCM types with different melting temperatures and thermal storage capacities. PCM types may include S46 with a melting point of approximately 46 °C (115 °F), S34 with a melting point of approximately 34 °C (93 °F), S32 with a melting point of approximately 32 °C (90 °F), S30 with a melting point of approximately 30 °C (86 °F), and S27 with a melting point of approximately 27 °C (81 °F). Each PCM type may have corresponding variations in their thermal storage capacities, energy storage per unit volume, and physical properties that may be selected based on specific application requirements and ambient operating conditions.

One or more embodiments may include phase change material integrated heat exchanger systems for battery thermal management. The phase change material integrated heat exchanger systems may provide an improvement in the functioning of the hardware performance of battery cells by reducing thermal stress during peak demand periods through thermal energy storage, thereby extending cell lifespan and preventing thermal degradation that can lead to capacity fade and reduced cycle life.

One or more embodiments may include controller-based thermal management systems that operate battery heat exchangers in multiple modes based on ambient temperature conditions. The controller-based thermal management systems may provide an improvement in the functioning of the hardware performance of cooling system components by reducing continuous operation requirements of HVAC and chiller units, thereby decreasing mechanical wear and extending equipment lifetime while reducing overall system energy consumption.

One or more embodiments may include PCM cooling systems with variable heat rejection pathways. The PCM cooling systems may provide an improvement in technology by enabling battery energy storage systems to operate at optimal temperatures during high-rate charging and discharging cycles without requiring oversized cooling equipment, thereby reducing capital costs while maintaining uniform temperature distribution across large battery arrays.

One or more embodiments may include thermal peak shaving capabilities through phase change material energy storage. The thermal peak shaving capabilities may provide an improvement in the functioning of the hardware performance of battery management systems by storing excess thermal energy during peak load periods and releasing it during favorable ambient conditions, thereby reducing the electrical power required for cooling during peak demand periods when the battery system needs to provide maximum power to the grid.

One or more embodiments may include temperature-based control algorithms for heat exchanger operation modes. The temperature-based control algorithms may provide an improvement in the functioning of the hardware performance of a computer by reducing computational load on battery management system controllers through simplified decision-making processes based on temperature thresholds, while simultaneously improving thermal management accuracy and system response times.

One or more embodiments may include economizer mode operation for cooling loops. The economizer mode operation may provide an improvement in technology by enabling direct heat rejection to ambient air using fans when favorable temperature differentials exist, thereby eliminating the need for vapor compression cycles and reducing energy consumption of the thermal management system by up to 20% based on PCM volume implementation.

One or more embodiments may include nighttime PCM charging capabilities. The nighttime PCM charging capabilities may provide an improvement in the functioning of the hardware performance of cooling systems by allowing thermal energy storage during periods of lower ambient temperatures and cheaper auxiliary power, thereby improving overall system efficiency and reducing operational costs while enabling smaller chiller units to operate over longer periods with reduced maintenance requirements.

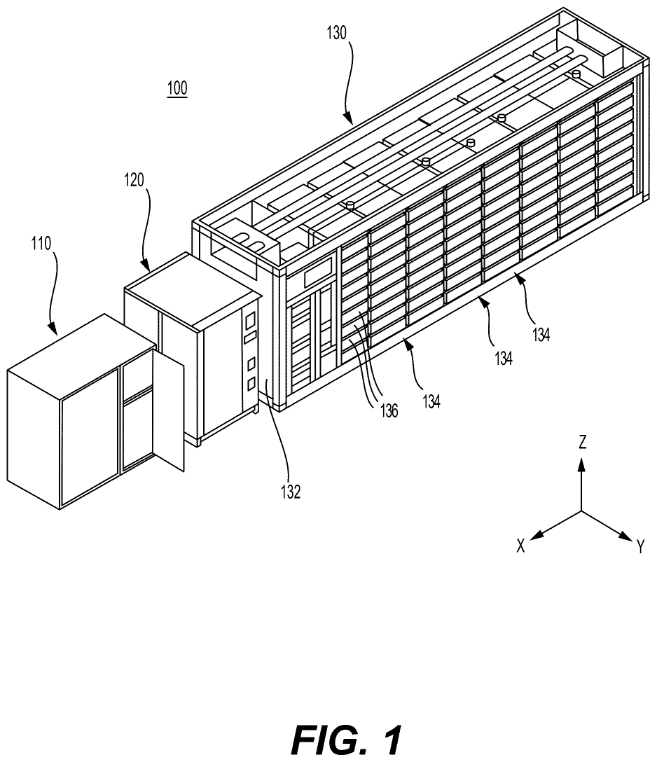

FIG. 1 depicts an exemplary battery system infrastructure, according to one or more embodiments. Battery energy storage system 100 may include battery control 110, battery thermal protection 120, and battery array 130. Battery array 130 may include housing 132 and battery rack 134 (e.g., one or more battery racks, eight battery racks).

Housing 132 may be a battery frame, for example. Battery rack 134 may include battery module 136 (e.g., one or more battery modules, nine battery modules). Battery module 136 may include one or more battery cells in a module case. Battery module 136 may be stacked in a direction, for example, in a vertical direction as battery rack 134. Battery rack 134 may include a rack case to facilitate stacking the battery module 136. Each battery module 136 may be received in a receiving space of the rack case as a module stack. One module stack may constitute one of battery rack 134. Alternatively, two or more module stacks may constitute one of battery rack 134.

Battery module 136 included in the battery rack 134 may further include a control unit such as a battery management system (BMS) for each battery module or each predetermined group. For example, each battery module 136 may include a pack BMS. A battery module 136 including a pack BMS may be referred to as a battery pack. For example, the battery rack 134 may include a plurality of battery packs. Alternatively, a battery pack assembly may include one or more battery cells with a module-less design, such as a direct cell-to-pack design, for example.

The battery rack 134 may be arranged in at least one direction, for example, a horizontal direction. For example, battery array 130 may include eight battery racks of battery rack 134 that may be arranged in the left-right direction (X-axis direction) in battery array 130. Each battery rack 134 may have a control unit, for example, a rack BMS. The rack BMS may be connected to the plurality of pack BMSs included in battery rack 134 to transmit and receive data to and from the plurality of pack BMSs and control them.

The rack BMS may be connected to a control device, for example, battery control 110. Battery rack 134 may include an integrated control unit such as, for example, a battery processing unit (BPU) which may perform communications or control operations with the plurality of rack BMSs.

Housing 132 may be a container housing. Housing 132 may have an empty internal space. Housing 132 may accommodate the battery rack 134 in the internal space. More specifically, as depicted in FIG. 1, housing 132 may be formed in the shape of an approximately rectangular prism. Housing 132 may include an upper housing, a lower housing, a front housing, a rear housing, a left housing, and a right housing with respect to the internal space. Housing 132 may accommodate the battery rack 134 in the internal space defined by these six unit housings.

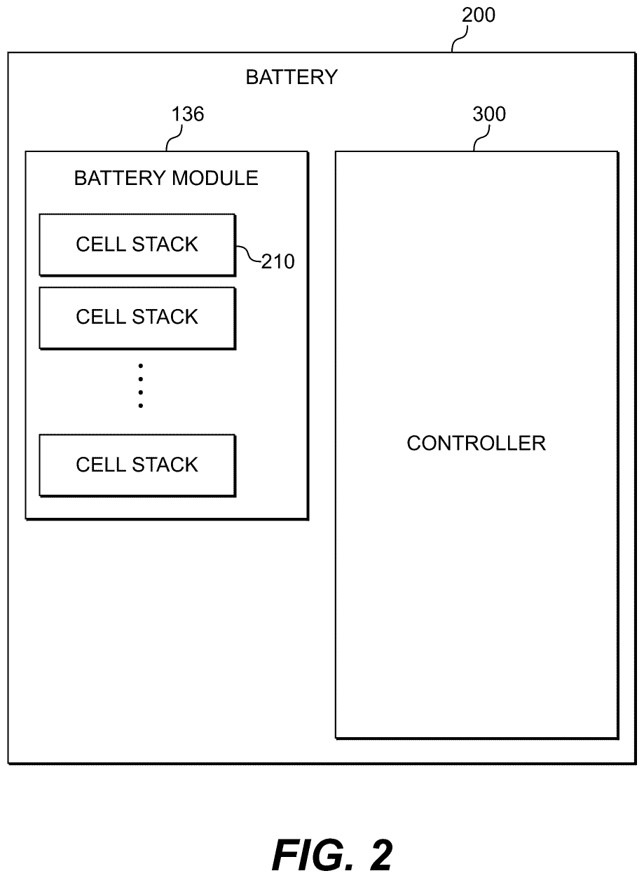

FIG. 2 depicts a battery, according to one or more embodiments. Battery 200 may include a battery module 136 and controller 300. Battery module 136 may include a plurality of cell stacks, including cell stack 210.

Battery 200 may include a battery pack. Battery 200 may include an overcharge prevention apparatus. Overcharge prevention apparatus may include a voltage measuring unit, a current regulating unit, a controller 300, and optionally may further include at least one of a disconnecting unit, a current measuring unit, and a cooling unit. Additionally, when the overcharge prevention apparatus includes a disconnecting unit, a discharge inducing unit may be included.

The plurality of cell stacks, which may include cell stack 210, may be connected in series and installed on a high current path between two power terminals of battery 200. A voltage measuring unit may measure the voltage of each cell stack 210, and may generate a first monitoring signal indicating the measured voltage. The first monitoring signal generated by the voltage measuring unit may be transmitted to the controller. The current regulating unit may be configured to selectively provide each cell stack 210 with bypass paths connected in parallel. Current regulating unit may provide bypass paths individually to the plurality of cell stacks, which may include for example cell stack 210.

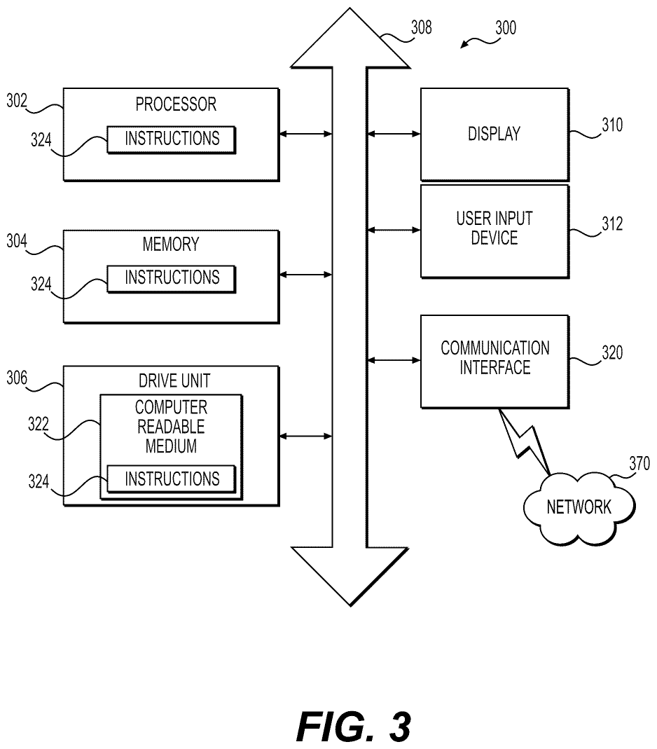

FIG. 3 depicts a controller, according to one or more embodiments. FIG. 3 and the following discussion provide a brief, general description of a suitable computing environment in which the present disclosure may be implemented. In one embodiment, any of the disclosed systems, methods, and/or graphical user interfaces may be executed by or implemented by a computing system consistent with or similar to that depicted in FIG. 3. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

The controller 300 may include a set of instructions that can be executed to cause the controller 300 to perform any one or more of the methods or computer-based functions disclosed herein. The controller 300 may operate as a standalone device or may be connected, e.g., using a network, to other computer systems or peripheral devices.

In a networked deployment, the controller 300 may operate in the capacity of a server or as a client in a server-client user network environment, or as a peer computer system in a peer-to-peer (or distributed) network environment. The controller 300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 300 can be implemented using electronic devices that provide voice, video, or data communication. Further, while the controller 300 is illustrated as a single system, the term “system” shall also be taken to include any collection of systems or sub-systems that individually or jointly execute a set, or multiple sets, of instructions to perform one or more computer functions.

As illustrated in FIG. 3, the controller 300 may include a processor 302, e.g., a central processing unit (CPU), a graphics processing unit (GPU), or both. The processor 302 may be a component in a variety of systems. For example, the processor 302 may be part of a standard computer. The processor 302 may be one or more general processors, digital signal processors, application specific integrated circuits, field programmable gate arrays, servers, networks, digital circuits, analog circuits, combinations thereof, or other now known or later developed devices for analyzing and processing data. The processor 302 may implement a software program, such as code generated manually (i.e., programmed).

The controller 300 may include a memory 304 that can communicate via a bus 308. The memory 304 may be a main memory, a static memory, or a dynamic memory. The memory 304 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media, and the like. In one implementation, the memory 304 includes a cache or random-access memory for the processor 302. In alternative implementations, the memory 304 is separate from the processor 302, such as a cache memory of a processor, the system memory, or other memory. The memory 304 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 304 is operable to store instructions executable by the processor 302. The functions, acts or tasks illustrated in the figures or described herein may be performed by the processor 302 executing the instructions stored in the memory 304. The functions, acts or tasks are independent of the particular type of instructions set, storage media, processor or processing strategy and may be performed by software, hardware, integrated circuits, firm-ware, micro-code, and the like, operating alone or in combination. Likewise, processing strategies may include multiprocessing, multitasking, parallel processing, and the like.

As shown, the controller 300 may further include a display 310, such as a liquid crystal display (LCD), an organic light emitting diode (OLED), a flat panel display, a solid-state display, a cathode ray tube (CRT), a projector, a printer or other now known or later developed display device for outputting determined information. The display 310 may act as an interface for the user to see the functioning of the processor 302, or specifically as an interface with the software stored in the memory 304 or in the drive unit 306.

Additionally or alternatively, the controller 300 may include an input device 312 configured to allow a user to interact with any of the components of controller 300. The input device 312 may be a number pad, a keyboard, or a cursor control device, such as a mouse, or a joystick, touch screen display, remote control, or any other device operative to interact with the controller 300.

The controller 300 may also or alternatively include drive unit 306 implemented as a disk or optical drive. The drive unit 306 may include a computer-readable medium 322 in which one or more sets of the instructions 324, e.g., software, can be embedded. Further, the instructions 324 may embody one or more of the methods or logic as described herein. The instructions 324 may reside completely or partially within the memory 304 and/or within the processor 302 during execution by the controller 300. The memory 304 and the processor 302 also may include computer-readable media as discussed above.

In some systems, a computer-readable medium 322 includes instructions 324 or receives and executes instructions 324 responsive to a propagated signal so that a device connected to a network 370 can communicate voice, video, audio, images, or any other data over the network 370. Further, the instructions 324 may be transmitted or received over the network 370 via a communication port or interface 320, and/or using a bus 308. The communication port or interface 320 may be a part of the processor 302 or may be a separate component. The communication port or interface 320 may be created in software or may be a physical connection in hardware. The communication port or interface 320 may be configured to connect with a network 370, external media, the display 310, or any other components in controller 300, or combinations thereof. The connection with the network 370 may be a physical connection, such as a wired Ethernet connection or may be established wirelessly as discussed below. Likewise, the additional connections with other components of the controller 300 may be physical connections or may be established wirelessly. The network 370 may alternatively be directly connected to a bus 308.

While the computer-readable medium 322 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 322 may be non-transitory, and may be tangible.

The computer-readable medium 322 can include a solid-state memory such as a memory card or other package that houses one or more non-volatile read-only memories. The computer-readable medium 322 can be a random-access memory or other volatile re-writable memory. Additionally or alternatively, the computer-readable medium 322 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 300 may be connected to a network 370. The network 370 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 370 may include wide area networks (WAN), such as the Internet, local area networks (LAN), campus area networks, metropolitan area networks, a direct connection such as through a Universal Serial Bus (USB) port, or any other networks that may allow for data communication. The network 370 may be configured to couple one computing device to another computing device to enable communication of data between the devices. The network 370 may generally be enabled to employ any form of machine-readable media for communicating information from one device to another. The network 370 may include communication methods by which information may travel between computing devices. The network 370 may be divided into sub-networks. The sub-networks may allow access to all of the other components connected thereto or the sub-networks may restrict access between the components. The network 370 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

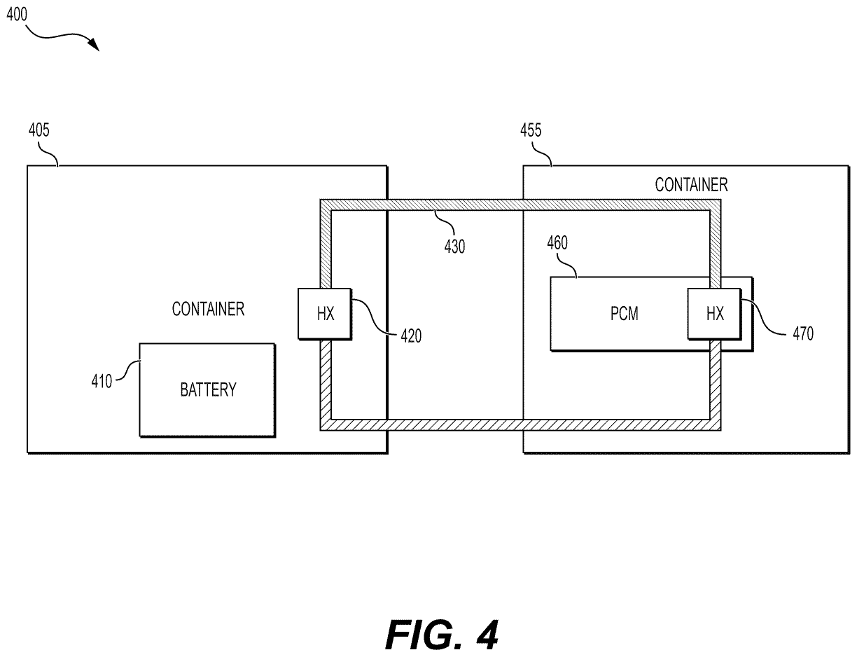

FIG. 4 depicts a thermal management system for battery energy storage applications, according to one or more embodiments. Referring to FIG. 4, a system 400 may provide thermal management for battery energy storage applications through phase change material integration. System 400 may include a battery container 405 and a PCM container 455 that may be configured to work together for thermal peak shaving applications. A battery 410 may be housed within battery container 405 and may generate heat during charging and discharging operations. A heat exchanger 420 may be positioned within battery container 405 and may be thermally coupled to battery 410 to remove heat generated during battery operation.

A heat exchanger conduit 430 may extend from heat exchanger 420 and may provide a fluid connection between battery container 405 and PCM container 455. Heat exchanger conduit 430 may enable circulation of liquid coolant between the two containers to facilitate heat transfer. PCM container 455 may contain a PCM 460 that may store thermal energy through phase change processes. A PCM heat exchanger 470 may be positioned within or adjacent to PCM 460 to facilitate thermal energy transfer between the liquid coolant and PCM 460.

The system 400 may be integrated into various installation configurations to accommodate different application requirements. Battery container 405 and PCM container 455 may be positioned within unit containers that may house the complete battery energy storage system. In some cases, the system 400 may be integrated into buildings or enclosures that may provide environmental protection and structural support for the thermal management components. The system 400 may also be configured for external positioning outside the primary unit, which may allow for separate maintenance access and may provide flexibility in system layout design.

During operation, heat exchanger 420 may transfer heat from battery 410 to a first liquid coolant that may circulate through heat exchanger conduit 430. The heat exchanger 420 may operate in multiple modes to manage thermal energy transfer. In a first mode, heat exchanger 420 may transfer heat from the first liquid coolant to air for direct heat rejection to the ambient environment. In a second mode, heat exchanger 420 may transfer heat from the first liquid coolant to PCM 460 through PCM heat exchanger 470 for thermal energy storage.

PCM heat exchanger 470 may transfer heat from PCM 460 to one or more of a second liquid coolant or air, depending on operating conditions and thermal management requirements. The controller 300 may control the battery assembly cooling system to operate heat exchanger 420 in each of the first mode or the second mode based on a temperature of the air and a temperature of PCM 460. The controller 300 may also control the PCM cooling system to transfer heat from PCM 460 to the one or more of the second liquid coolant or the air based on the temperature of the air and the temperature of PCM 460.

The heat exchanger system may transfer heat from battery 410 to the liquid coolant when a temperature of battery 410 may be greater than a temperature of the liquid coolant. The heat exchanger system may transfer heat from the liquid coolant to PCM 460 when the temperature of the liquid coolant may be greater than a temperature of PCM 460. The heat exchanger system may transfer heat from PCM 460 to the liquid coolant when the temperature of PCM 460 may be greater than the temperature of the liquid coolant. The heat exchanger system may transfer heat from PCM 460 to air when the temperature of PCM 460 may be greater than the temperature of the air.

A melting point of PCM 460 may be from approximately 0 degrees F to approximately 100 degrees F, which may enable thermal energy storage across a range of operating temperatures suitable for battery energy storage applications. PCM 460 may be configured to transition from a solid to a liquid at the melting point, which may provide latent heat storage capacity during the phase change process. Battery container 405 may serve as a first enclosure for the battery assembly, while PCM container 455 may serve as a second enclosure for PCM 460, which may allow for independent maintenance and optimization of each thermal management component.

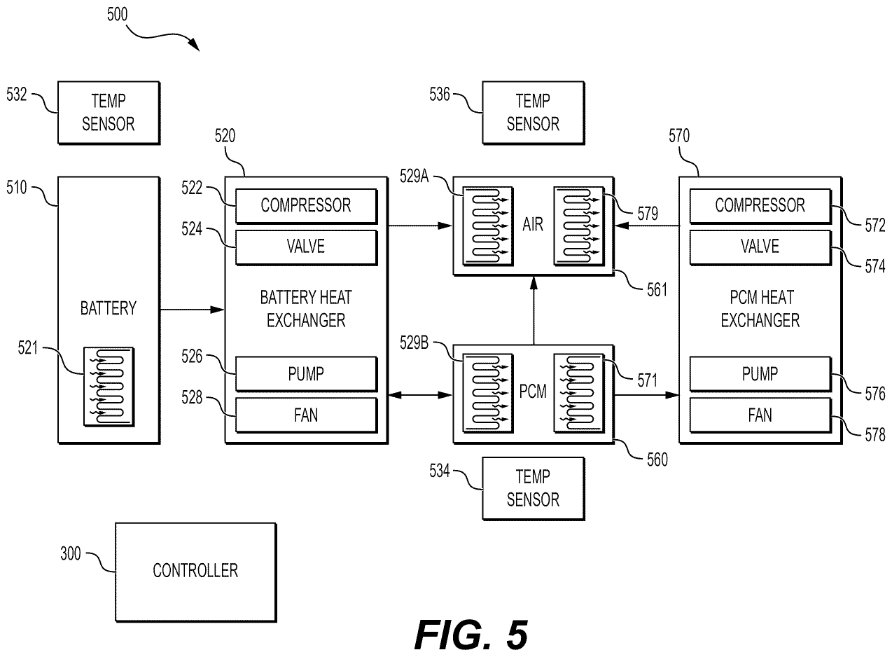

FIG. 5 depicts a detailed thermal management system for battery energy storage applications, according to one or more embodiments. Referring to FIG. 5, a system 500 may provide comprehensive thermal management for battery energy storage applications through an integrated phase change material cooling architecture. System 500 may include a battery assembly 510 that may house one or more battery modules for energy storage operations. A battery heat exchanger 520 may be thermally coupled to battery assembly 510 to manage heat generated during charging and discharging cycles.

Battery heat exchanger 520 may include a battery system cooling plate 521 that may be positioned in direct thermal contact with battery assembly 510 to facilitate heat transfer from the battery modules to a first liquid coolant. A battery system compressor 522 may circulate refrigerant through battery heat exchanger 520 to enable vapor compression cooling cycles. A battery system valve 524 may control refrigerant flow direction and pressure within battery heat exchanger 520. A battery system pump 526 may circulate the first liquid coolant through cooling channels within battery system cooling plate 521.

A battery system fan 528 may move air across heat exchange surfaces to facilitate convective heat transfer. Battery heat exchanger 520 may include a battery system air condenser 529A that may transfer heat from the first liquid coolant to air for direct ambient heat rejection. Battery heat exchanger 520 may also include a battery system PCM condenser 529B that may transfer heat from the first liquid coolant to a PCM 560 for thermal energy storage applications.

System 500 may include multiple temperature sensors to monitor thermal conditions throughout the thermal management system. A battery system temperature sensor 532 may monitor the temperature of battery assembly 510 to provide feedback for thermal control algorithms. An air temperature sensor 534 may monitor ambient air temperature to determine favorable conditions for heat rejection to the environment. A PCM temperature sensor 536 may monitor the temperature of PCM 560 to track phase change states and thermal energy storage capacity.

PCM 560 may store thermal energy through phase change processes and may be positioned between battery system PCM condenser 529B and a PCM heat exchanger 570. A PCM heat exchanger 570 may be configured to exchange thermal energy with PCM 560 through multiple heat transfer mechanisms. PCM heat exchanger 570 may include a PCM system coil 571 that may circulate a second liquid coolant through PCM 560 to transfer heat from PCM 560 to the second liquid coolant.

A PCM system compressor 572 may provide vapor compression cooling for PCM heat exchanger 570 to enable active heat removal from PCM 560. A PCM system valve 574 may control refrigerant flow and pressure within PCM heat exchanger 570. A PCM system pump 576 may circulate the second liquid coolant through PCM system coil 571 to facilitate heat transfer between PCM 560 and the cooling system.

A PCM system fan 578 may move air across PCM 560 to transfer heat from PCM 560 to air through convective heat transfer. PCM heat exchanger 570 may include a PCM system air condenser 579 that may transfer heat from the second liquid coolant to air after the second liquid coolant absorbs thermal energy from PCM 560. Controller 300 may be operatively connected to the various components of system 500 to manage thermal operation based on temperature measurements from battery system temperature sensor 532, air temperature sensor 534, and PCM temperature sensor 536.

System 500 may enable ground heat sink operation where thermal energy may be rejected to ground temperature in addition to air temperature heat rejection. The ground heat sink capability may provide an additional thermal pathway that may be particularly advantageous when ambient air temperatures exceed optimal heat rejection conditions. The system may utilize ground-coupled heat exchangers that may transfer thermal energy to the earth's thermal mass, which may maintain relatively stable temperatures throughout seasonal variations.

Controller 300 may control battery heat exchanger 520 to operate in multiple modes based on thermal conditions. In a first mode, battery heat exchanger 520 may transfer heat from the first liquid coolant to air through battery system air condenser 529A when the temperature of PCM 560 may be greater than the temperature of the air. In a second mode, battery heat exchanger 520 may transfer heat from the first liquid coolant to PCM 560 through battery system PCM condenser 529B when the temperature of PCM 560 may be less than the temperature of the air.

Controller 300 may control battery heat exchanger 520 to operate in a third mode where heat may be transferred from the first liquid coolant to both the air and PCM 560 simultaneously when a temperature of battery assembly 510 may be greater than the temperature of PCM 560. This dual heat rejection mode may provide enhanced thermal management capacity during peak battery loading conditions.

System 500 may enable nighttime PCM charging operations where PCM 560 may be charged at freezing temperature during nighttime periods when cooling systems may operate at more efficient outdoor temperatures and auxiliary power may be available at reduced cost. Controller 300 may activate PCM system compressor 572 and PCM system pump 576 during nighttime hours to transfer thermal energy from PCM 560 to the ambient environment, thereby solidifying PCM 560 and storing cooling capacity for subsequent daytime battery cooling requirements.

The cooling loop may operate in an economizer mode where heat may be rejected directly to outdoor ambient conditions using battery system fan 528 and PCM system fan 578 when favorable temperature differentials exist between the system components and ambient air. Controller 300 may bypass vapor compression cycles and may rely on fan-only operation when the temperature of the air may be sufficiently low to provide adequate heat rejection without mechanical cooling assistance.

System 500 may enable fan-only PCM charging when outdoor temperature may be lower than the melting temperature of PCM 560. Controller 300 may activate PCM system fan 578 to move ambient air across PCM 560 without operating PCM system compressor 572, thereby utilizing natural temperature differentials to solidify PCM 560 and store cooling capacity. This fan-only charging mode may reduce energy consumption while maintaining thermal energy storage capabilities during favorable ambient conditions.

Controller 300 may control the PCM cooling system to transfer heat from PCM 560 to the second liquid coolant and from the second liquid coolant to air through PCM system air condenser 579 when the temperature of PCM 560 may be greater than a freezing temperature of PCM 560 and less than the temperature of the air. Controller 300 may control the PCM cooling system to transfer heat from PCM 560 to air through PCM system fan 578 when the temperature of PCM 560 may be greater than the freezing temperature of PCM 560 and greater than the temperature of the air.

Battery assembly 510 may include one or more battery modules, and battery heat exchanger 520 may include one or more cooling plates with one or more cooling channels for the first liquid coolant to transfer heat from the one or more battery modules to the first liquid coolant. Battery system cooling plate 521 may provide direct thermal contact with individual battery modules within battery assembly 510 to ensure uniform temperature distribution across the battery array.

Battery system PCM condenser 529B may be positioned at PCM 560 to transfer heat from the first liquid coolant to PCM 560, while PCM system coil 571 may function as a PCM evaporator at PCM 560 to transfer heat from PCM 560 to the second liquid coolant. This configuration may enable bidirectional heat transfer between the battery cooling system and the PCM thermal storage system, allowing PCM 560 to function as both a heat sink during battery cooling operations and a heat source during PCM discharge operations.

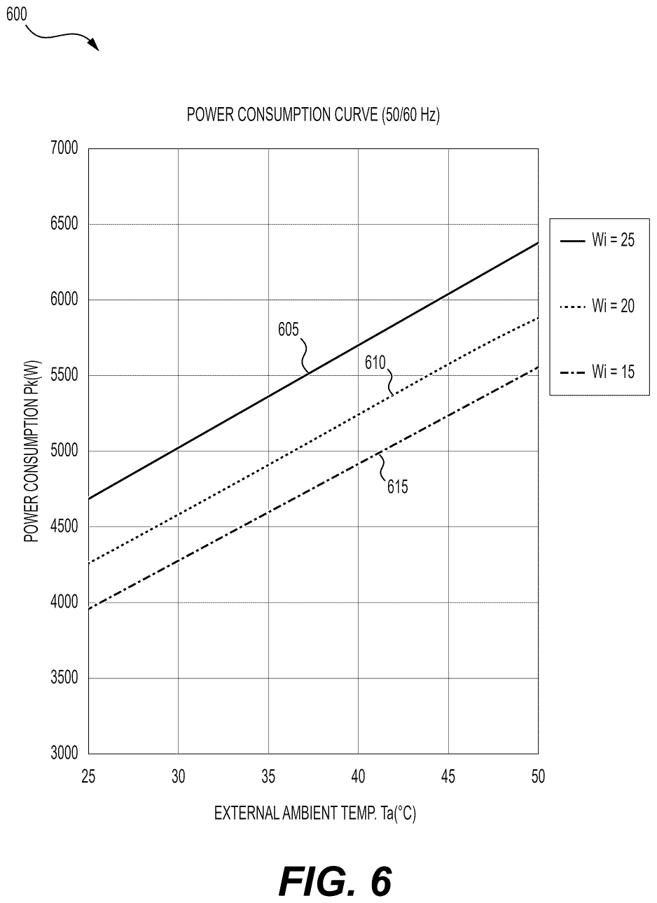

FIG. 6 depicts a power consumption graph showing power consumption at different operating conditions, according to one or more embodiments. Referring to FIG. 6, a power consumption graph 600 may illustrate the relationship between external ambient temperature and power consumption for thermal management systems under different operating conditions. The power consumption graph 600 may demonstrate how cooling system power requirements may vary with ambient temperature conditions and may provide insights into thermal management optimization strategies for battery energy storage applications.

The power consumption graph 600 may include a first curve 605, a second curve 610, and a third curve 615 that may represent different operating scenarios for thermal management systems. A first curve 605 may correspond to Wi=25 operating conditions and may show power consumption ranging from approximately 4700 kW at 25 °C external ambient temperature to approximately 6400 kW at 50 °C external ambient temperature. The first curve 605 may demonstrate the highest power consumption profile among the three operating conditions, indicating increased cooling system energy requirements under these particular operating parameters.

A second curve 610 may correspond to Wi=20 operating conditions and may show intermediate power consumption levels ranging from approximately 4300 kW at 25 °C external ambient temperature to approximately 5900 kW at 50 °C external ambient temperature. The second curve 610 may demonstrate reduced power consumption compared to the first curve 605, which may indicate improved thermal management efficiency under these operating conditions. The power consumption reduction shown by the second curve 610 may result from improved cooling system operation or enhanced thermal management strategies. Second curve 610 may correspond with daytime temperature operating point conditions.

A third curve 615 may correspond to Wi=15 operating conditions and may show the lowest power consumption profile ranging from approximately 4000 kW at 25 °C external ambient temperature to approximately 5500 kW at 50 °C external ambient temperature. The third curve 615 may demonstrate the most efficient thermal management operation among the three curves, which may indicate optimal cooling system performance under these operating parameters. The reduced power consumption shown by the third curve 615 may result from enhanced phase change material integration or improved heat exchanger operation modes. Third curve 615 may correspond with nighttime temperature operating point conditions.

The power consumption graph 600 may demonstrate that power consumption may increase substantially as external ambient temperature increases from 25 °C to 50 °C across all three operating conditions. This temperature-dependent power consumption relationship may highlight the importance of thermal management optimization for battery energy storage systems, particularly during high ambient temperature conditions when cooling system energy requirements may be at their peak.

The power consumption differences between the first curve 605, the second curve 610, and the third curve 615 may illustrate the potential energy savings achievable through improved thermal management system design and operation. The controller 300 may utilize temperature measurements from the air temperature sensor 534 to determine optimal operating modes that may minimize power consumption while maintaining adequate thermal management performance for the battery assembly 510.

The power consumption characteristics shown in the power consumption graph 600 may demonstrate the benefits of implementing phase change material thermal management systems that may reduce cooling system energy requirements during peak ambient temperature conditions. The PCM 560 may provide thermal energy storage capacity that may reduce the power consumption required by the battery system compressor 522 and the PCM system compressor 572 during high ambient temperature periods when conventional cooling systems may operate at reduced efficiency. One or more embodiments may provide manipulation or lowering of the condenser sink temperature using PCM (for example, PCM 560) to either reduce power consumption or increase effective cooling capacity.

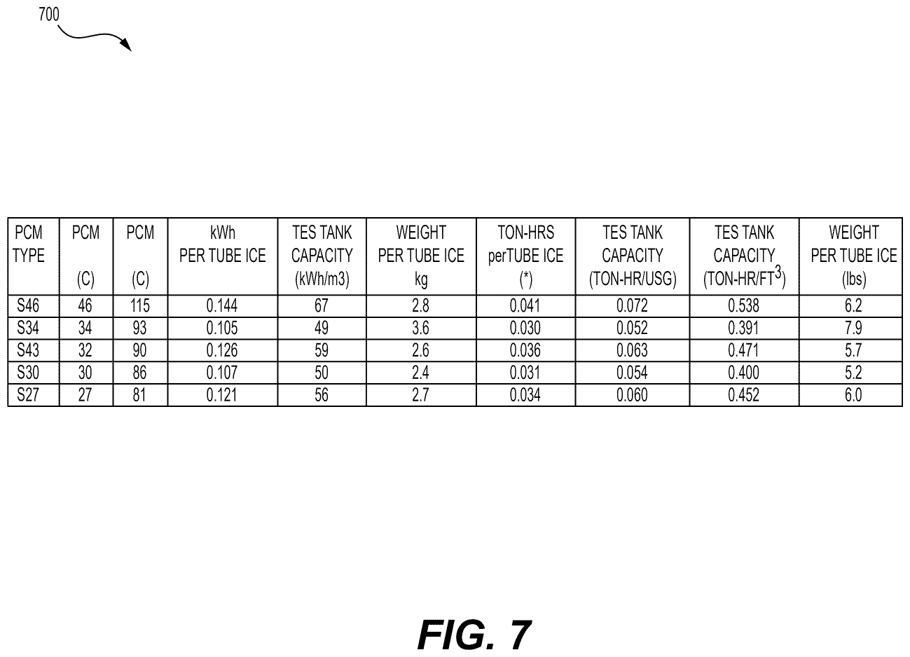

FIG. 7 depicts a phase change material properties table, according to one or more embodiments. Referring to FIG. 7, a PCM properties table 700 may display various characteristics of different phase change materials for thermal energy storage applications in battery energy storage systems. The PCM properties table 700 may include comprehensive data for five specific PCM types that may be selected based on application requirements and ambient operating conditions.

The PCM properties table 700 may include data for PCM type S46 that may have a melting point of 46 °C (115 °F). The S46 PCM type may provide thermal energy storage capacity of 67 kWh per cubic meter, which may represent the highest thermal storage density among the PCM types shown in the PCM properties table 700. The S46 PCM type may be suitable for applications where higher melting temperatures may be advantageous for thermal management in elevated ambient temperature environments.

The PCM properties table 700 may include data for PCM type S34 that may have a melting point of 34 °C (93 °F). The S34 PCM type may provide thermal energy storage capacity of 49 kWh per cubic meter. The S34 PCM type may offer intermediate thermal storage characteristics that may be suitable for moderate ambient temperature applications where the melting point may provide effective thermal peak shaving capabilities.

The PCM properties table 700 may include data for PCM type S32 that may have a melting point of 32 °C (90 °F). The S32 PCM type may provide thermal energy storage capacity of 59 kWh per cubic meter. The S32 PCM type may be selected for applications where the melting temperature may align with typical battery operating temperature ranges while providing substantial thermal energy storage capacity.

The PCM properties table 700 may include data for PCM type S30 that may have a melting point of 30 °C (86 °F). The S30 PCM type may provide thermal energy storage capacity of 50 kWh per cubic meter. The S30 PCM type may offer thermal management capabilities for applications where lower melting temperatures may be beneficial for enhanced heat absorption during battery charging and discharging cycles.

The PCM properties table 700 may include data for PCM type S27 that may have a melting point of 27 °C (81 °F). The S27 PCM type may provide thermal energy storage capacity of 56 kWh per cubic meter. The S27 PCM type may be particularly suitable for battery energy storage applications where the relatively low melting temperature may enable effective thermal energy storage during typical battery operating conditions.

The thermal energy storage capacities shown in the PCM properties table 700 may range from 49 to 67 kWh per cubic meter depending on the specific PCM type selected. These thermal energy storage capacities may enable the controller 300 to select optimal PCM types based on specific battery energy storage system requirements and ambient operating conditions. The PCM 560 may be selected from any of the PCM types shown in the PCM properties table 700 to provide thermal management capabilities tailored to specific application requirements.

The system 500 may be designed for specific battery energy storage applications including 1,200 kW BES 4 hour systems that may require approximately 35 kW peak cooling capacity. The battery assembly 510 may generate an average of approximately 15 kW thermal load during charge and discharge cycles. The thermal load calculation may equal 15 kW multiplied by 4 hours, resulting in 60 kWh total thermal energy that may need to be managed by the thermal management system.

For applications utilizing S27 PCM type, the tank capacity may equal 56 kWh per cubic meter as shown in the PCM properties table 700. The tank volume may be approximately 1 cubic meter to accommodate the 60 kWh thermal load requirement for the 1,200 kW BES 4 hour system. The PCM container 455 may be sized to contain approximately 1 cubic meter of the selected PCM 560 to provide adequate thermal energy storage capacity.

For alternative battery energy storage system configurations, the thermal load may be approximately 75 kW average during operation. The system 500 may accommodate these higher thermal loads through selection of appropriate PCM types from the PCM properties table 700 and corresponding adjustments to the PCM container 455 volume to maintain adequate thermal energy storage capacity.

The implementation of 1 cubic meter of PCM 560 may reduce the cooling load by approximately 20 percent for battery energy storage systems. This twenty percent load reduction may be achieved through thermal peak shaving where the PCM 560 may absorb thermal energy during peak battery loading periods and may release the stored thermal energy during periods when ambient conditions may be favorable for heat rejection. The controller 300 may manage this thermal peak shaving operation by controlling the battery heat exchanger 520 and the PCM heat exchanger 570 based on temperature measurements from the battery system temperature sensor 532, the air temperature sensor 534, and the PCM temperature sensor 536.

The melting point of the PCM 560 may be from approximately 0 degrees F to approximately 100 degrees F, which may encompass the temperature ranges of the PCM types shown in the PCM properties table 700. This temperature range may enable selection of appropriate PCM types for various climate conditions and battery operating requirements. The PCM 560 may transition from a solid to a liquid at the melting point, providing latent heat storage capacity that may be substantially greater than sensible heat storage capacity alone.

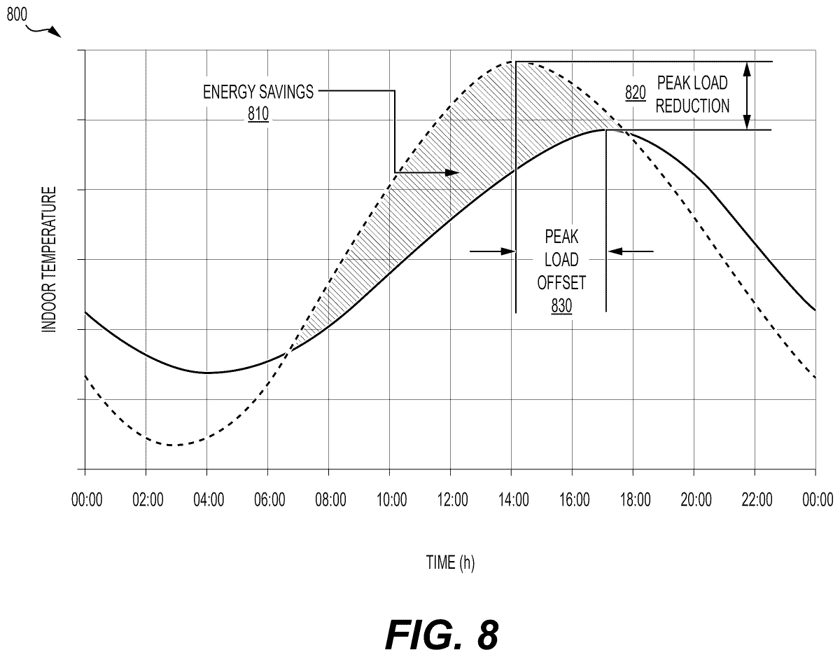

FIG. 8 depicts an energy graph illustrating thermal management benefits, according to one or more embodiments. Referring to FIG. 8, an energy graph 800 may illustrate thermal management benefits achieved through phase change material implementation in battery energy storage systems over a 24-hour operational period. The energy graph 800 may demonstrate the performance advantages of integrating PCM 560 with the system 500 to provide enhanced thermal management capabilities compared to conventional cooling approaches. The energy graph 800 may show temperature variations plotted against time, with two distinct performance curves representing system operation with and without phase change material thermal management integration.

The energy graph 800 may include a solid line curve that may represent thermal performance with phase change material implementation, while a dashed line curve may show baseline thermal performance without PCM integration. The temperature profiles shown in the energy graph 800 may demonstrate how the controller 300 may manage thermal energy transfer through the battery heat exchanger 520 and the PCM heat exchanger 570 to achieve improved thermal management performance throughout the 24-hour operational cycle.

Energy savings 810 may be represented by a hatched area between the two performance curves during approximately the 10:00 to 14:00 hour period. The energy savings 810 may demonstrate the reduction in energy consumption achieved during the daytime heating period when ambient temperatures may be elevated and conventional cooling systems may operate at reduced efficiency. The energy savings 810 may result from the thermal energy storage capacity of PCM 560, which may absorb heat from the battery assembly 510 through the battery system PCM condenser 529B during peak thermal load periods.

The controller 300 may achieve the energy savings 810 by controlling the battery heat exchanger 520 to operate in the second mode where heat may be transferred from the first liquid coolant to PCM 560 when the temperature of PCM 560 may be less than the temperature of the air. During this operational mode, the battery system compressor 522 and the battery system pump 526 may operate at reduced power levels because the PCM 560 may provide thermal energy absorption capacity that may supplement conventional air-based heat rejection through the battery system air condenser 529A.

A peak load reduction 820 may be shown as a vertical double-headed arrow on the right side of the energy graph 800. The peak load reduction 820 may demonstrate the decrease in maximum temperature achieved through the use of PCM 560 in the thermal management system. The peak load reduction 820 may result from the latent heat absorption capacity of PCM 560 during the phase change process from solid to liquid state, which may occur when the temperature of the battery assembly 510 may exceed the melting point of PCM 560.

The controller 300 may achieve the peak load reduction 820 by monitoring the battery system temperature sensor 532 and controlling the battery heat exchanger 520 to transfer heat from the first liquid coolant to PCM 560 through the battery system PCM condenser 529B. The peak load reduction 820 may enable the battery assembly 510 to operate at lower peak temperatures, which may extend battery life and may improve overall system performance by reducing thermal stress on individual battery modules within the battery assembly 510.

A peak load offset 830 may be indicated by vertical arrows showing the time shift between the peak temperatures of the two performance curves. The peak load offset 830 may illustrate how PCM 560 may delay the occurrence of peak thermal load from approximately 14:00 to 18:00 hours. The peak load offset 830 may result from the thermal energy storage capacity of PCM 560, which may absorb thermal energy during peak battery loading periods and may release the stored thermal energy during periods when ambient conditions may be more favorable for heat rejection.

The controller 300 may manage the peak load offset 830 by controlling the PCM heat exchanger 570 to transfer heat from PCM 560 to air through the PCM system fan 578 when the temperature of PCM 560 may be greater than the temperature of the air. The air temperature sensor 534 may provide temperature measurements that may enable the controller 300 to determine optimal timing for heat rejection from PCM 560 to the ambient environment. The peak load offset 830 may enable the system 500 to utilize cooler evening ambient temperatures for heat rejection, which may improve overall thermal management efficiency.

The thermal management benefits shown in the energy graph 800 may demonstrate how the controller 300 may control a heat exchanger system of the battery electronic storage system to control a temperature of the battery assembly 510. The controller 300 may transfer heat from the battery assembly 510 to a first liquid coolant through the battery system cooling plate 521, may transfer heat from the first liquid coolant to air through the battery system air condenser 529A, and may transfer heat from the first liquid coolant to PCM 560 through the battery system PCM condenser 529B.

The controller 300 may transfer heat from PCM 560 to one or more of the first liquid coolant or a second liquid coolant through the PCM system coil 571, and may transfer heat from PCM 560 to air through the PCM system fan 578. The controller 300 may transfer heat from PCM 560 to air when a temperature of PCM 560 may be greater than a temperature of the air, as demonstrated during the evening hours shown in the energy graph 800. The controller 300 may transfer heat from PCM 560 to the one or more of the first liquid coolant or the second liquid coolant when the temperature of PCM 560 may be less than the temperature of the air, which may occur during nighttime charging operations when ambient temperatures may be reduced.

The energy graph 800 may demonstrate that the integration of PCM 560 with the system 500 may provide substantial thermal management benefits including the energy savings 810, the peak load reduction 820, and the peak load offset 830. These thermal management benefits may enable battery energy storage systems to operate more efficiently while reducing cooling system power consumption and extending battery life through improved temperature control. The controller 300 may utilize temperature measurements from the battery system temperature sensor 532, the air temperature sensor 534, and the PCM temperature sensor 536 to improve thermal management performance throughout the 24-hour operational cycle shown in the energy graph 800.

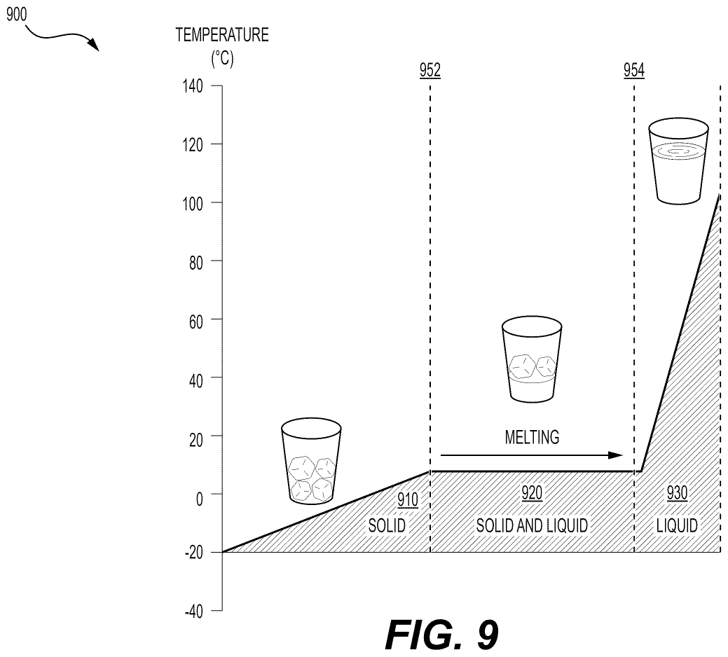

FIG. 9 depicts a phase change material phase graph, according to one or more embodiments. Referring to FIG. 9, a PCM phase graph 900 may illustrate the relationship between temperature in degrees Celsius and the phase states of a phase change material during a melting process. The PCM phase graph 900 may demonstrate the thermal behavior characteristics of PCM 560 that may enable thermal energy storage through phase transition processes in the system 500. The PCM phase graph 900 may provide temperature-dependent phase state information that may be utilized by the controller 300 to improve thermal management operations based on measurements from the PCM temperature sensor 536.

The PCM phase graph 900 may show three distinct phases that may occur as temperature increases across the operational range. A solid phase 910 may occur at lower temperatures where PCM 560 may exist in a solid state and may provide sensible heat storage capacity. The solid phase 910 may extend across a temperature range from approximately −20 °C to the onset of phase transition, where PCM 560 may absorb thermal energy through temperature increase without undergoing phase change.

A solid and liquid phase 920 may represent the transition region during melting where PCM 560 may exist simultaneously in both solid and liquid states. The solid and liquid phase 920 may demonstrate the constant temperature characteristic during the phase transition process, where thermal energy absorption may occur through latent heat storage rather than temperature increase. The solid and liquid phase 920 may extend horizontally on the PCM phase graph 900, indicating that substantial thermal energy may be absorbed or released without corresponding temperature change during the phase transition process.

A liquid phase 930 may occur at higher temperatures where PCM 560 may exist completely in a liquid state after the phase transition process may be complete. The liquid phase 930 may show a steep temperature increase from the completion of phase transition to approximately 100 °C, indicating that PCM 560 may again provide sensible heat storage capacity through temperature increase once the phase change process may be complete.

A melting point 952 may mark the temperature at which PCM 560 may begin to transition from solid to liquid state, occurring at approximately 10 °C as shown in the PCM phase graph 900. The melting point 952 may correspond to the onset of the solid and liquid phase 920 where latent heat absorption may begin. The controller 300 may utilize temperature measurements from the PCM temperature sensor 536 to determine when PCM 560 may reach the melting point 952 and may begin providing enhanced thermal energy storage capacity through phase change processes.

A melted point 954 may indicate the temperature at which PCM 560 may have completely transitioned to liquid state, also occurring at approximately 10 °C as shown in the PCM phase graph 900. The melted point 954 may correspond to the completion of the solid and liquid phase 920 where latent heat absorption may be complete and PCM 560 may transition to the liquid phase 930. The melting point 952 and the melted point 954 may occur at the same temperature, demonstrating that the phase transition may occur at a constant temperature characteristic that may enable predictable thermal energy storage behavior.

The constant temperature characteristic during the phase transition between the melting point 952 and the melted point 954 may enable PCM 560 to absorb substantial thermal energy without corresponding temperature increase. This constant temperature behavior may provide enhanced thermal management capabilities for the battery assembly 510 by maintaining stable temperatures during peak thermal loading conditions. The controller 300 may control the battery heat exchanger 520 to transfer heat from the first liquid coolant to PCM 560 through the battery system PCM condenser 529B when the temperature of PCM 560 may be at or near the melting point 952.

The PCM 560 may be configured to transition from a solid to a liquid at the melting point 952, which may provide latent heat storage capacity that may be substantially greater than sensible heat storage capacity alone. The transition from solid to liquid state may occur when thermal energy may be transferred from the battery assembly 510 through the battery heat exchanger 520 to PCM 560. The phase transition process may enable PCM 560 to absorb thermal energy from the battery assembly 510 while maintaining relatively constant temperature, thereby providing enhanced thermal management performance during peak battery loading conditions.

The PCM phase graph 900 may demonstrate that the latent heat storage capacity during the solid and liquid phase 920 may provide substantially greater thermal energy storage compared to sensible heat storage during the solid phase 910 or the liquid phase 930. The controller 300 may improve thermal management operations by controlling the PCM heat exchanger 570 to maintain PCM 560 at temperatures near the melting point 952 where maximum thermal energy storage capacity may be available through the phase transition process.

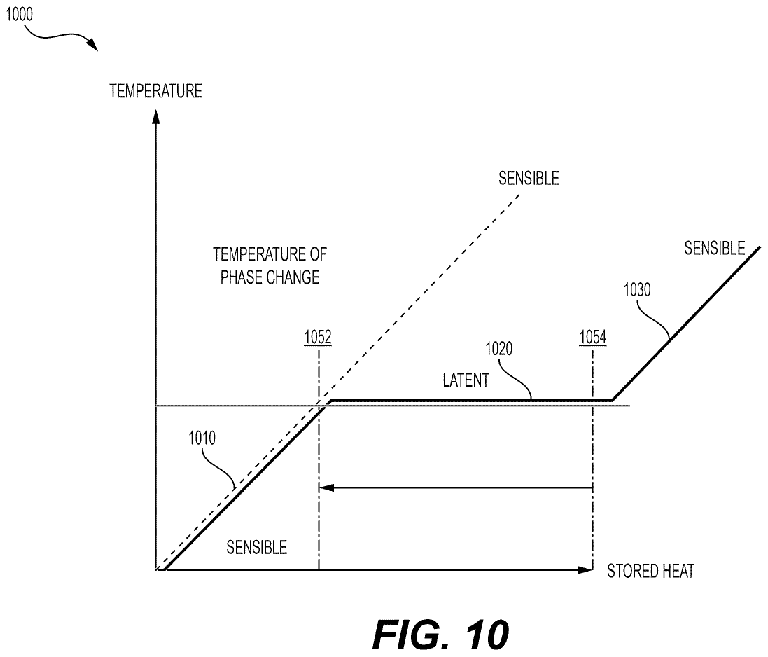

FIG. 10 depicts a phase change graph illustrating temperature and stored heat relationships, according to one or more embodiments. Referring to FIG. 10, a phase change graph 1000 may illustrate the relationship between temperature and stored heat for a phase change material during thermal energy storage processes. The phase change graph 1000 may demonstrate the thermal energy storage characteristics of the PCM 560 that may enable enhanced thermal management capabilities in the system 500. The phase change graph 1000 may provide quantitative relationships between temperature and thermal energy storage that may be utilized by the controller 300 to improve thermal management operations based on measurements from the PCM temperature sensor 536.

The phase change graph 1000 may show three distinct regions that may correspond to different thermal energy storage mechanisms during the heating process. A solid sensible region 1010 may occur at lower temperatures where the PCM 560 may exist in a solid state and may store thermal energy through temperature increase. The solid sensible region 1010 may demonstrate a linear relationship between temperature and stored heat, where thermal energy absorption may result in proportional temperature increase without phase change occurring.

The solid sensible region 1010 may extend from the lowest temperatures shown on the phase change graph 1000 up to a melting point 1052 where phase transition may begin. During operation in the solid sensible region 1010, the controller 300 may control the battery heat exchanger 520 to transfer heat from the first liquid coolant to the PCM 560 through the battery system PCM condenser 529B, resulting in temperature increase of the PCM 560 while maintaining solid phase characteristics.

A latent region 1020 may occur where temperature may remain constant during the phase change process while substantial thermal energy may be absorbed or released. The latent region 1020 may demonstrate the constant temperature characteristic during phase transition, where thermal energy storage may occur through latent heat absorption rather than temperature increase. The latent region 1020 may extend horizontally on the phase change graph 1000, indicating that substantial thermal energy may be stored without corresponding temperature change during the phase transition process.

The latent region 1020 may provide the greatest thermal energy storage capacity per unit temperature range compared to the solid sensible region 1010 or a liquid sensible region 1030. The controller 300 may improve thermal management operations by maintaining the PCM 560 within the latent region 1020 where maximum thermal energy storage capacity may be available. The PCM temperature sensor 536 may provide temperature measurements that may enable the controller 300 to determine when the PCM 560 may be operating within the latent region 1020.

The liquid sensible region 1030 may occur at higher temperatures where the PCM 560 may exist completely in a liquid state after the phase change process may be complete. The liquid sensible region 1030 may show a linear relationship between temperature and stored heat similar to the solid sensible region 1010, where thermal energy absorption may result in proportional temperature increase. The liquid sensible region 1030 may extend from a melted point 1054 where phase transition may be complete to the highest temperatures shown on the phase change graph 1000.

The melting point 1052 may mark the temperature at which the PCM 560 may begin to transition from the solid sensible region 1010 to the latent region 1020. The melting point 1052 may correspond to the onset of phase change where latent heat absorption may begin and temperature may remain constant despite continued thermal energy input. The controller 300 may utilize temperature measurements from the PCM temperature sensor 536 to determine when the PCM 560 may reach the melting point 1052 and may begin providing enhanced thermal energy storage capacity through phase change processes.

The melted point 1054 may indicate the temperature at which the PCM 560 may have completely transitioned from the latent region 1020 to the liquid sensible region 1030. The melted point 1054 may correspond to the completion of phase change where latent heat absorption may be complete and the PCM 560 may resume temperature increase with continued thermal energy input. The melting point 1052 and the melted point 1054 may occur at the same temperature value, demonstrating that the phase transition may occur at a constant temperature characteristic.

The phase change graph 1000 may include diagonal dashed and solid lines labeled “SENSIBLE” that may extend through the solid sensible region 1010 and the liquid sensible region 1030 respectively. These sensible heat lines may demonstrate the linear temperature-heat relationship that may occur when the PCM 560 may store thermal energy through temperature change rather than phase change. The sensible heat storage characteristics may provide predictable thermal energy storage behavior that may be utilized by the controller 300 for thermal management optimization.

The thermal energy storage capacity shown in the latent region 1020 may be substantially greater than the thermal energy storage capacity available in either the solid sensible region 1010 or the liquid sensible region 1030 for equivalent temperature ranges. This enhanced thermal energy storage capacity during phase change may enable the PCM 560 to absorb substantial thermal energy from the battery assembly 510 while maintaining relatively stable temperatures, thereby providing enhanced thermal management performance during peak battery loading conditions.

The controller 300 may control the PCM heat exchanger 570 to transfer heat from the PCM 560 to air through the PCM system fan 578 or to transfer heat from the PCM 560 to the second liquid coolant through the PCM system coil 571 based on the thermal energy storage characteristics shown in the phase change graph 1000. The air temperature sensor 534 may provide ambient temperature measurements that may enable the controller 300 to determine optimal timing for heat rejection from the PCM 560 when the PCM 560 may be operating in the liquid sensible region 1030 after thermal energy storage in the latent region 1020 may be complete.

There are several technical advantages of the phase change material heat exchanger system for battery energy storage applications of the present disclosure. First, the integration of phase change materials with battery thermal management systems may provide thermal peak shaving capabilities that reduce the electrical power consumption required for cooling during high-demand periods, thereby improving overall system efficiency and reducing operational costs. Additionally, the system may enable reduced power consumption for cooling systems by storing cooling capacity at the PCM melting temperature, allowing thermal energy to be stored during periods of lower ambient temperatures and cheaper auxiliary power, particularly during nighttime operations.

Furthermore, the multi-mode operation capability may allow the cooling loop to operate in an economizer mode that rejects heat directly to outdoor ambient air using fans when favorable temperature differentials exist, eliminating the need for vapor compression cycles and reducing energy consumption by up to 20% based on PCM volume implementation. The system may also reduce the number of HVAC and chiller units required for battery thermal management, as PCM can be charged without a vapor compression cycle utilizing fans when outdoor temperature is lower than the melting temperature, or with smaller chiller units that operate over longer periods, thereby reducing maintenance requirements and capital costs. Moreover, the thermal energy storage capabilities may enable battery energy storage systems to operate at optimal temperatures during high-rate charging and discharging cycles without requiring oversized cooling equipment, maintaining uniform temperature distribution across large battery arrays while extending battery cell lifespan by reducing thermal stress and preventing thermal degradation that can lead to capacity fade and reduced cycle life. These technical advantages may collectively contribute to a more efficient, cost-effective, and reliable thermal management solution for battery energy storage systems.

It should be understood that the foregoing description is intended to illustrate, and not to limit, the scope of the present disclosure. Other embodiments will be apparent to those skilled in the art in view of this description. For example, while certain embodiments are described with respect to lithium-ion batteries, the disclosed structures, materials, and methods may be applied to next-generation energy storage devices including, without limitation, solid-state batteries employing solid electrolytes, lithium-metal or lithium-sulfur chemistries, sodium-ion systems, multivalent-ion systems (e.g., magnesium, calcium, aluminum), zinc-based or redox flow batteries, and metal-air cells. Still further embodiments may include architectures employing silicon-based anodes, cobalt-free cathodes, or advanced electrolyte formulations. In some cases, anode-less designs, in which active material is plated during charge, or separator-free designs, in which the electrolyte provides ionic conduction and electronic insulation without a discrete separator, may be implemented. The present disclosure also contemplates hybridized devices combining electrochemical cells with supercapacitors, as well as integration into applications such as electric or hybrid vehicles, stationary energy storage systems, aerospace platforms, and portable electronics. Accordingly, the scope of the present invention should be determined not by the particular embodiments described, but by reference to the appended claims and their equivalents.

The present disclosure further relates to the following aspects.

Example 1. A battery electronic storage system comprising: a battery assembly; a battery assembly cooling system, the battery assembly cooling system including: a phase change material (PCM), and a battery heat exchanger to transfer heat from the battery assembly to a first liquid coolant, and to transfer heat from the first liquid coolant in a first mode and a second mode, wherein the battery heat exchanger operates in the first mode to transfer heat from the first liquid coolant to air and operates in the second mode to transfer heat from the first liquid coolant to the PCM; a PCM cooling system, the PCM cooling system including a PCM heat exchanger to transfer heat from the PCM to one or more of a second liquid coolant or air; and one or more controllers configured to: control the battery assembly cooling system to operate the battery heat exchanger in each of the first mode or the second mode, based on a temperature of the air and a temperature of the PCM, and control the PCM cooling system to transfer heat from the PCM to the one or more of the second liquid coolant or the air, based on the temperature of the air and the temperature of the PCM.

Example 2. The battery electronic storage system of example 1, wherein the one or more controllers are further configured to: control the battery assembly cooling system to operate the battery heat exchanger in the first mode to transfer heat from the first liquid coolant to air when the temperature of the PCM is greater than the temperature of the air, control the battery assembly cooling system to operate the battery heat exchanger in the second mode to transfer heat from the first liquid coolant to the PCM when the temperature of the PCM is less than the temperature of the air, and control the PCM cooling system to transfer heat from the PCM to the one or more of the second liquid coolant or the air when the temperature of the PCM is greater than the temperature of the air.

Example 3. The battery electronic storage system of example 1, wherein the one or more controllers are further configured to: control the battery assembly cooling system to operate the battery heat exchanger in a third mode to transfer heat from the first liquid coolant to both the air and the PCM when a temperature of the battery assembly is greater than the temperature of the PCM.

Example 4. The battery electronic storage system of example 1, wherein the one or more controllers are further configured to: control the PCM cooling system to transfer heat from the PCM to the second liquid coolant and from the second liquid coolant to the air when the temperature of the PCM is greater than a freezing temperature of the PCM and less than the temperature of the air, and control the PCM cooling system to transfer heat from the PCM to the air when the temperature of the PCM is greater than the freezing temperature of the PCM and greater than the temperature of the air.

Example 5. The battery electronic storage system of example 1, wherein: the battery assembly includes one or more battery modules, and the battery heat exchanger includes one or more cooling plates with one or more cooling channels for the first liquid coolant to transfer heat from the one or more battery modules to the first liquid coolant.

Example 6. The battery electronic storage system of example 1, wherein the battery heat exchanger includes a battery system air condenser to transfer heat from the first liquid coolant to air.

Example 7. The battery electronic storage system of example 1, wherein the battery heat exchanger includes a battery system PCM condenser to transfer heat from the first liquid coolant to the PCM.

Example 8. The battery electronic storage system of example 1, wherein the PCM heat exchanger includes one or more fans to move air across the PCM to transfer heat from the PCM to the air.

Example 9. The battery electronic storage system of example 1, wherein the PCM heat exchanger includes one or more PCM system coils for the second liquid coolant to transfer heat from the PCM to the second liquid coolant.

Example 10. The battery electronic storage system of example 9, wherein the PCM heat exchanger includes a PCM system condenser to transfer heat from the second liquid coolant to air.

Example 11. The battery electronic storage system of example 1, wherein: the battery heat exchanger includes a battery system PCM condenser at the PCM to transfer heat from the first liquid coolant to the PCM, and the PCM heat exchanger includes a PCM evaporator at the PCM to transfer heat from the PCM to the second liquid coolant.

Example 12. A battery electronic storage system comprising: a battery assembly; a battery assembly cooling system, the battery assembly cooling system including: a liquid coolant, a phase change material (PCM), and a heat exchanger system to transfer heat from the battery assembly to the liquid coolant, to transfer heat from the liquid coolant to air, to transfer heat from the liquid coolant to the PCM, to transfer heat from the PCM to the liquid coolant, and to transfer heat from the PCM to air, and one or more controllers configured to control the heat exchanger system based on a temperature of the battery assembly, a temperature of the liquid coolant, a temperature of the air, and a temperature of the PCM.

Example 13. The battery electronic storage system of example 12, wherein the one or more controllers are configured to control the heat exchanger system: to transfer heat from the battery assembly to the liquid coolant when a temperature of the battery assembly is greater than a temperature of the liquid coolant, to transfer heat from the liquid coolant to air when the temperature of the liquid coolant is greater than a temperature of the air, to transfer heat from the liquid coolant to the PCM when the temperature of the liquid coolant is greater than a temperature of the PCM, to transfer heat from the PCM to the liquid coolant when the temperature of the PCM is greater than the temperature of the liquid coolant, and to transfer heat from the PCM to air when the temperature of the PCM is greater than the temperature of the air.

Example 14. The battery electronic storage system of example 12, wherein a melting point of the PCM is from approximately 0 degrees F to approximately 100 degrees F.

Example 15. The battery electronic storage system of example 14, wherein the PCM is configured to transition from a solid to a liquid at the melting point.

Example 16. The battery electronic storage system of example 14, further comprising: a first enclosure for the battery assembly; and a second enclosure for the PCM.

Example 17. A battery management system comprising: one or more controllers configured to control a battery electronic storage system including a battery assembly, wherein the one or more controllers are configured to control a heat exchanger system of the battery electronic storage system to control a temperature of the battery assembly, and to transfer heat from the battery assembly to a first liquid coolant, to transfer heat from the first liquid coolant to air, to transfer heat from the first liquid coolant to a phase change material (PCM), to transfer heat from the PCM to one or more of the first liquid coolant or a second liquid coolant, and to transfer heat from the PCM to air.

Example 18. The battery management system of example 17, wherein the one or more controllers are further configured to control the heat exchanger system to: transfer heat from the PCM to air when a temperature of the PCM is greater than a temperature of the air, and transfer heat from the PCM to the one or more of the first liquid coolant or the second liquid coolant when the temperature of the PCM is less than the temperature of the air.

Example 19. The battery management system of example 17, wherein the one or more controllers are further configured to control the heat exchanger system to transfer heat from the PCM to the first liquid coolant when the heat exchanger system is configured to cool both the battery assembly and the PCM using the first liquid coolant.

Example 20. The battery management system of example 17, wherein the one or more controllers are further configured to control the heat exchanger system to transfer heat from the PCM to the second liquid coolant when the heat exchanger system is configured to cool both the battery assembly using the first liquid coolant and the PCM using the second liquid coolant.

Example 21. A non-transitory computer readable medium for a battery management system configured to control a battery electronic storage system including a battery assembly, the non-transitory computer readable medium storing instructions that, when executed by one or more processors, cause the one or more processors to: control a heat exchanger system of the battery electronic storage system to control a temperature of the battery assembly, and to transfer heat from the battery assembly to a first liquid coolant, to transfer heat from the first liquid coolant to air, to transfer heat from the first liquid coolant to a phase change material (PCM), to transfer heat from the PCM to one or more of the first liquid coolant or a second liquid coolant, and to transfer heat from the PCM to air. Example 22. The non-transitory computer readable medium of example 21, wherein the operations further include any of examples 18 to 20.

Example 23. A method for a battery management system configured to control a battery electronic storage system including a battery assembly, the method comprising: controlling, by one or more processors, a heat exchanger system of the battery electronic storage system to control a temperature of the battery assembly, and to transfer heat from the battery assembly to a first liquid coolant, to transfer heat from the first liquid coolant to air, to transfer heat from the first liquid coolant to a phase change material (PCM), to transfer heat from the PCM to one or more of the first liquid coolant or a second liquid coolant, and to transfer heat from the PCM to air.

Example 24. The method of example 21, wherein the operations further include any of examples 18 to 20.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A battery electronic storage system comprising:
a battery assembly;
a battery assembly cooling system, the battery assembly cooling system including:
a phase change material (PCM), and
a battery heat exchanger to transfer heat from the battery assembly to a first liquid coolant, and to transfer heat from the first liquid coolant in a first mode and a second mode, wherein the battery heat exchanger operates in the first mode to transfer heat from the first liquid coolant to air and operates in the second mode to transfer heat from the first liquid coolant to the PCM;
a PCM cooling system, the PCM cooling system including a PCM heat exchanger to transfer heat from the PCM to one or more of a second liquid coolant or air; and
one or more controllers configured to:
control the battery assembly cooling system to operate the battery heat exchanger in each of the first mode or the second mode, based on a temperature of the air and a temperature of the PCM, and
control the PCM cooling system to transfer heat from the PCM to the one or more of the second liquid coolant or the air, based on the temperature of the air and the temperature of the PCM.

2. The battery electronic storage system of claim 1, wherein the one or more controllers are further configured to:
control the battery assembly cooling system to operate the battery heat exchanger in the first mode to transfer heat from the first liquid coolant to air when the temperature of the PCM is greater than the temperature of the air,
control the battery assembly cooling system to operate the battery heat exchanger in the second mode to transfer heat from the first liquid coolant to the PCM when the temperature of the PCM is less than the temperature of the air, and
control the PCM cooling system to transfer heat from the PCM to the one or more of the second liquid coolant or the air when the temperature of the PCM is greater than the temperature of the air.

3. The battery electronic storage system of claim 1, wherein the one or more controllers are further configured to:
control the battery assembly cooling system to operate the battery heat exchanger in a third mode to transfer heat from the first liquid coolant to both the air and the PCM when a temperature of the battery assembly is greater than the temperature of the PCM.

4. The battery electronic storage system of claim 1, wherein the one or more controllers are further configured to:
control the PCM cooling system to transfer heat from the PCM to the second liquid coolant and from the second liquid coolant to the air when the temperature of the PCM is greater than a freezing temperature of the PCM and less than the temperature of the air, and
control the PCM cooling system to transfer heat from the PCM to the air when the temperature of the PCM is greater than the freezing temperature of the PCM and greater than the temperature of the air.

5. The battery electronic storage system of claim 1, wherein:
the battery assembly includes one or more battery modules, and
the battery heat exchanger includes one or more cooling plates with one or more cooling channels for the first liquid coolant to transfer heat from the one or more battery modules to the first liquid coolant.

6. The battery electronic storage system of claim 1, wherein the battery heat exchanger includes a battery system air condenser to transfer heat from the first liquid coolant to air.

7. The battery electronic storage system of claim 1, wherein the battery heat exchanger includes a battery system PCM condenser to transfer heat from the first liquid coolant to the PCM.

8. The battery electronic storage system of claim 1, wherein the PCM heat exchanger includes one or more fans to move air across the PCM to transfer heat from the PCM to the air.

9. The battery electronic storage system of claim 1, wherein the PCM heat exchanger includes one or more PCM system coils for the second liquid coolant to transfer heat from the PCM to the second liquid coolant.

10. The battery electronic storage system of claim 9, wherein the PCM heat exchanger includes a PCM system condenser to transfer heat from the second liquid coolant to air.

11. The battery electronic storage system of claim 1, wherein:
the battery heat exchanger includes a battery system PCM condenser at the PCM to transfer heat from the first liquid coolant to the PCM, and
the PCM heat exchanger includes a PCM evaporator at the PCM to transfer heat from the PCM to the second liquid coolant.

12. A battery electronic storage system comprising:
a battery assembly;
a battery assembly cooling system, the battery assembly cooling system including:
a liquid coolant,
a phase change material (PCM), and
a heat exchanger system to transfer heat from the battery assembly to the liquid coolant, to transfer heat from the liquid coolant to air, to transfer heat from the liquid coolant to the PCM, to transfer heat from the PCM to the liquid coolant, and to transfer heat from the PCM to air, and
one or more controllers configured to control the heat exchanger system based on a temperature of the battery assembly, a temperature of the liquid coolant, a temperature of the air, and a temperature of the PCM.

13. The battery electronic storage system of claim 12, wherein the one or more controllers are configured to control the heat exchanger system:
to transfer heat from the battery assembly to the liquid coolant when a temperature of the battery assembly is greater than a temperature of the liquid coolant,
to transfer heat from the liquid coolant to air when the temperature of the liquid coolant is greater than a temperature of the air,
to transfer heat from the liquid coolant to the PCM when the temperature of the liquid coolant is greater than a temperature of the PCM,
to transfer heat from the PCM to the liquid coolant when the temperature of the PCM is greater than the temperature of the liquid coolant, and
to transfer heat from the PCM to air when the temperature of the PCM is greater than the temperature of the air.

14. The battery electronic storage system of claim 12, wherein a melting point of the PCM is from approximately 0 degrees F to approximately 100 degrees F.

15. The battery electronic storage system of claim 14, wherein the PCM is configured to transition from a solid to a liquid at the melting point.

16. The battery electronic storage system of claim 14, further comprising:
a first enclosure for the battery assembly; and
a second enclosure for the PCM.

17. A battery management system comprising:
one or more controllers configured to control a battery electronic storage system including a battery assembly,
wherein the one or more controllers are configured to control a heat exchanger system of the battery electronic storage system to control a temperature of the battery assembly, and to transfer heat from the battery assembly to a first liquid coolant, to transfer heat from the first liquid coolant to air, to transfer heat from the first liquid coolant to a phase change material (PCM), to transfer heat from the PCM to one or more of the first liquid coolant or a second liquid coolant, and to transfer heat from the PCM to air.

18. The battery management system of claim 17, wherein the one or more controllers are further configured to control the heat exchanger system to:
transfer heat from the PCM to air when a temperature of the PCM is greater than a temperature of the air, and
transfer heat from the PCM to the one or more of the first liquid coolant or the second liquid coolant when the temperature of the PCM is less than the temperature of the air.

19. The battery management system of claim 17, wherein the one or more controllers are further configured to control the heat exchanger system to transfer heat from the PCM to the first liquid coolant when the heat exchanger system is configured to cool both the battery assembly and the PCM using the first liquid coolant.

20. The battery management system of claim 17, wherein the one or more controllers are further configured to control the heat exchanger system to transfer heat from the PCM to the second liquid coolant when the heat exchanger system is configured to cool both the battery assembly using the first liquid coolant and the PCM using the second liquid coolant.
